(19) United States
(12) Patent Application Publication
(10) Pub. No.: US 2026/0359295 A1
(43) Pub. Date: Nov. 12, 2026

(54) METHODS, SYSTEMS, AND APPARATUSES FOR DETERMINISTIC COMPUTING OF ANALYTICS

(71) Applicant: QlikTech International AB, Lund (SE)

(72) Inventors: Nasser Bumpus, Boston, MA (US); Alexei Pogrebtsov, Ottawa (CA); José Díaz López, Lund (SE)

(21) Appl. No.: 19/674,917

(22) Filed: May 12, 2026

Related U.S. Application Data
(60) Provisional application No. 63/804,527, filed on May 12, 2025.

(51) Int. Cl. G06F 16/2452; G06F 16/22; G06F 16/9035; G06N 5/04

(52) U.S. Cl. CPC G06F 16/24522; G06F 16/2237; G06F 16/9035; G06N 5/04

(57) ABSTRACT

Described herein are methods, systems, and apparatuses for deterministic computing of analytics using an in-memory associative engine. An assistant application may receive a current question and classify the question into one or more analysis types prior to invoking a large language model. The system may compare terms of the current question against vectorized profiles of a plurality of analytical applications to identify at least one analytical application without requiring prior user selection. Based on metadata mapping information and filter information, the system may generate a retrieval query, and retrieve context from analytical applications and knowledge bases. The system may generate a visualization by performing calculations using the in-memory associative engine, wherein calculation results are deterministic and traceable independently of the large language model. The system may generate a mapping explanation identifying how the question was interpreted.

### CROSS-REFERENCE TO RELATED PATENT APPLICATION

This application claims priority to U.S. Prov. App. No. 63/804,527, filed on May 12, 2025, the entirety of which is incorporated by reference herein.

### BACKGROUND

Natural language processing and data analytics have become increasingly important in various industries. These technologies enable organizations to extract valuable insights from vast amounts of unstructured data. However, current systems often struggle with accurately interpreting complex queries, providing contextually relevant responses, and integrating information from multiple sources. Additionally, many existing solutions lack the ability to handle both structured and unstructured data seamlessly. There is a growing need for more advanced systems that can process natural language queries efficiently, analyze diverse data types, and generate meaningful insights. Improved methods for data visualization and interactive exploration could also enhance user understanding and decision-making capabilities. As the volume and complexity of data continue to grow, developing more sophisticated natural language processing and data analytics tools remains an ongoing challenge in the field. These and other considerations are described herein.

### SUMMARY

It is to be understood that both the following general description and the following detailed description are exemplary and explanatory only and are not restrictive. This summary is not intended to identify critical or essential features of the disclosure, but merely to summarize certain features and variations thereof. Other details and features will be described in the sections that follow.

Described herein are methods, systems, and apparatuses for deterministic computing of analytics. In some examples, structured and unstructured content may be transformed into embeddings stored in vector databases, knowledge bases, or related indexes. An assistant application may receive a current question and determine metadata mapping information and filter information. Based on the metadata mapping information and the filter information, the system may generate a retrieval query, retrieve context from analytical applications and knowledge bases, and optionally re-rank the retrieved context. The system may generate a response as well as transparent explanations identifying how the question was interpreted, which mappings and filters were identified, which sources were used, and what assumptions were made. Other examples and variations are possible as well.

### BRIEF DESCRIPTION OF THE DRAWINGS

The accompanying drawings, which are incorporated in and constitute a part of this specification, together with the description, serve to explain the principles of the present methods and systems:

FIG. 1A illustrates a block diagram of a system for data processing and analysis.

FIG. 1B illustrates a block diagram of a system for transforming data into indexed representations and for processing queries.

FIG. 1C illustrates a block diagram of an architecture for handling natural-language queries.

FIG. 2A illustrates a block diagram of a processing system for handling natural-language queries.

FIG. 2B illustrates a block diagram of a processing flow for generating a visualization payload.

FIG. 2C illustrates a block diagram of an alternative processing flow for generating a response payload.

FIG. 3 illustrates a flowchart of a method for processing natural-language queries.

FIG. 4A illustrates an answer interface.

FIG. 4B illustrates an explanation interface.

FIG. 5 illustrates a block diagram of a system for generating smart sheets using a smart sheet agent.

FIG. 6 illustrates a flowchart of a method for processing follow-up questions and generating updated responses.

FIG. 7A illustrates an answer interface presenting an inventory versus sales visualization.

FIG. 7B illustrates the answer interface of FIG. 7A alongside an explanation interface.

FIG. 7C illustrates an answer-saving interface.

FIG. 7D illustrates an unavailable-answer interface.

FIG. 7E illustrates a query-entry interface with corresponding answer outputs.

FIG. 7F illustrates a narrative answer card associated with the query-entry interface of FIG. 7E.

FIG. 7G illustrates a graphical answer card associated with the query-entry interface of FIG. 7E.

FIG. 7H illustrates an answer card associated with the query-entry interface of FIG. 7E.

FIG. 7I illustrates an answer card with a source-detail panel.

FIG. 7J illustrates the answer card of FIG. 7I with additional source details.

FIG. 7K illustrates an answer card with a follow-up action input.

FIG. 7L illustrates the answer card of FIG. 7K with a source-detail and explanation panel.

FIG. 7M illustrates a purchase order interface.

FIG. 8 illustrates a block diagram of a computing environment.

FIG. 9 illustrates a flowchart of a method for processing natural-language queries and generating responses.

FIG. 10 illustrates a flowchart of a method for processing natural-language queries via an assistant interface.

FIG. 11 illustrates a flowchart of a method for processing natural-language queries using cross-application routing.

FIG. 12 illustrates a flowchart of a method for processing natural-language queries using pre-classification and an in-memory associative engine.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

As used herein, the terms “assistant” and “agent” may refer to software-based components configured to receive queries, perform tasks, generate responses, coordinate with other components, or execute operations autonomously or in response to user input. An assistant or agent may operate within a multi-tiered architecture and may function with varying degrees of autonomy, ranging from responding to explicit user requests to independently initiating actions, delegating subtasks, or invoking downstream services without requiring step-by-step user direction. These terms may be used interchangeably throughout this disclosure unless otherwise specified.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

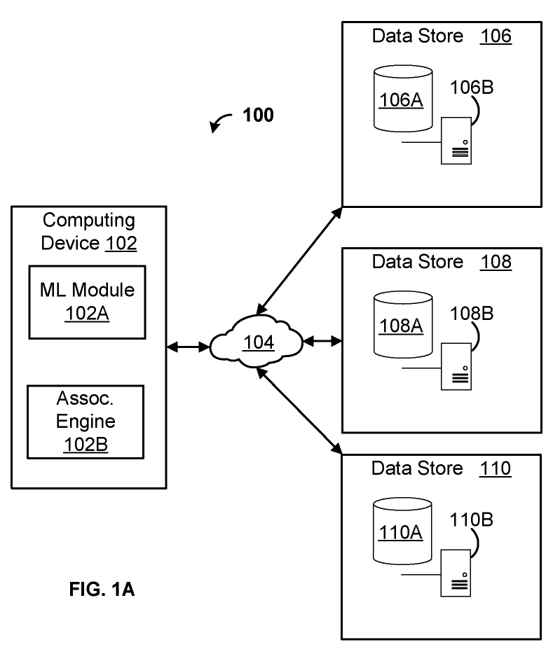

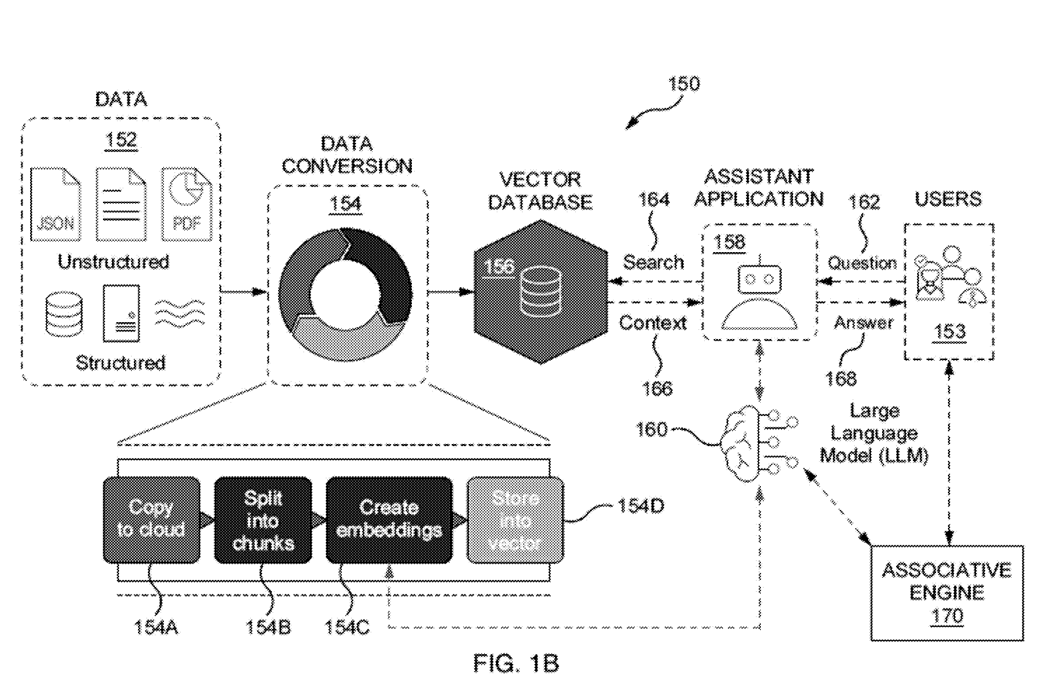

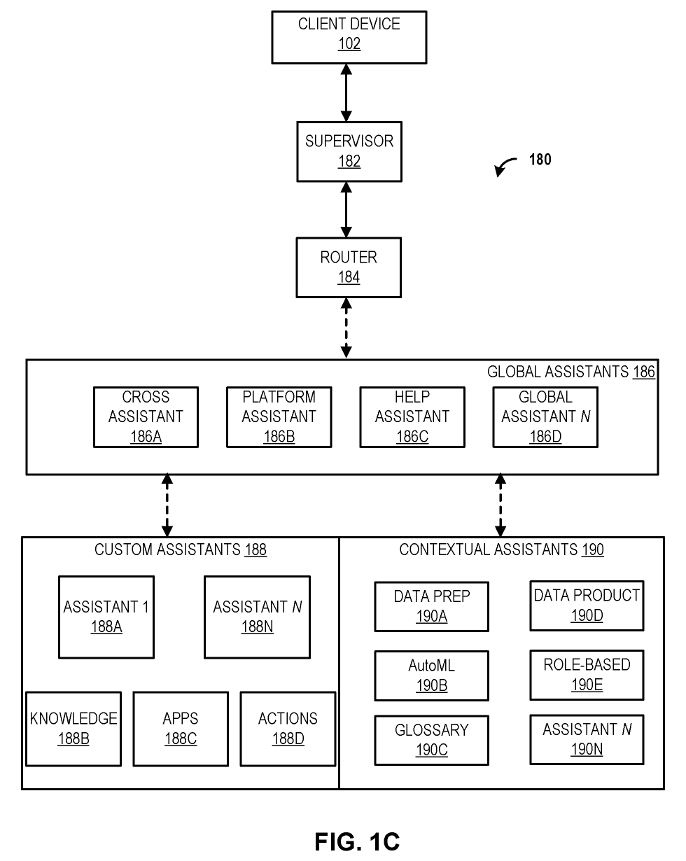

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide near-instantaneous calculation of aggregates, selections, and filters as further described herein.

Each of the plurality of data stores 106, 108, 110 may comprise one or more data storage mechanisms, such as a relational database, a cloud data warehouse, an object store, a search index, a vector database, an application repository, a file system, a software-as-a-service platform, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may include one or more local-area networks, wide-area networks, cloud networks, virtual private networks, optical fiber networks, cellular networks, wireless networks, or combinations thereof. The network 104 may support secure connectivity to source systems, data connections, scheduled refresh operations, event-driven triggers, real-time application programming interfaces, and machine-to-machine communications. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a data analytics platform, a data warehouse, a customer relationship management system, or other types of systems. This integration may allow the system 100 to access additional data, provide more comprehensive insights, or offer additional features to the users. In some aspects, the system 100 environment may include containerized services, orchestration platforms, serverless functions, message queues, streaming systems, or specialized hardware accelerators such as graphics processing units, tensor processors, or inference accelerators. The disclosed methods may be deployed in a multitenant cloud environment, a private cloud, an on-premises installation, or a hybrid environment.

As an example, turning now to FIG. 1B, an example system 150 is shown. The system 150 may comprise one or more components of the system 100, as further described herein. That is, the capabilities of the system 150 as described herein also apply to the system 100, as the two systems may share – or may each comprise – each described component, resource, device, etc., that performs each of the actions described herein (and potentially not shown). As shown in FIG. 1B, the system 150 may further comprise an associative engine 170. The associative engine 170 may correspond to the AE module 102B of the computing device 102 shown in FIG. 1A. The associative engine 170 may store one or more data models in-memory and manage associations between data elements, providing near-instantaneous calculation of aggregates, selections, and filters.

In some aspects, the associative engine 170 may implement associative selection propagation. When a user 153 makes a selection in an application, the associative engine 170 may instantly perform logical inference across an entire data model, determining what is possible, what is related, and what is not. Every visualization, every number, and every data point in an entire application may update simultaneously to reflect a new context. The associative engine 170 may provide deterministic calculations such that the same query run multiple times returns the same result. This deterministic behavior may be independent of any large language model processing, such as processing by the LLM 160. The associative engine 170 may reveal not just “what is” but also “what is not” by identifying excluded values that are not related to a current context.

At its core, the associative engine 170 (which may correspond to the AE module 102B of the computing device 102 shown in FIG. 1A) may perform a transformation during data loading. Instead of storing data as traditional rows and columns, the associative engine 170 may create two distinct structures: data tables and symbol tables. Symbol tables may contain one row per distinct value for each field, acting as lookup tables. The actual data tables may contain the same structure as a traditional database, but instead of data, they may contain only bit-stuffed pointers that are indices pointing back to the symbol tables. The bit-stuffed pointers may be compressed, using only the exact number of bits needed to represent the distinct values in each field. If a field has four distinct values, the pointer may be only two bits long. If a field has 256 distinct values, the pointer may use eight bits. This bit-stuffing may create compression while maintaining fidelity. In the associative engine 170, columns may not be typed in the manner of a regular database. Instead, each cell may be typed, using only the memory needed.

The associative engine 170 may maintain state vectors. The state vectors may be binary arrays that track the status of every data point and field value in an application. When selections are made by the user 153, the state vectors may instantly update to reflect which field values are selected, possible, alternative, or excluded, which records in data tables are included in a current context, which calculations need to be updated, and what relationships exist in a current state. This state management system may enable the associative engine 170 to maintain global context across an entire application while supporting performance even with complex selections and large datasets stored in the data stores 106, 108, 110.

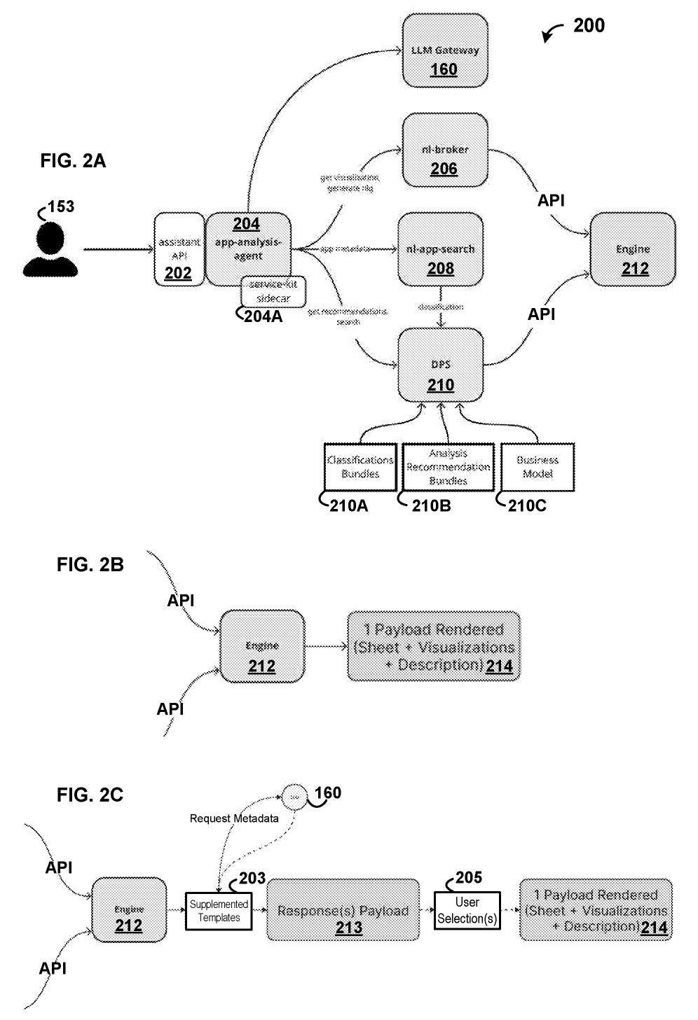

For calculations and visualizations, the associative engine 170 may use hypercubes. Hypercubes may be dynamic, multi-dimensional data structures that organize information for analytical computation. Hypercubes may handle complex aggregations across multiple dimensions simultaneously. Hypercubes may be created on-demand based on specific analytical needs, may handle millions of data points, and may be optimized for the types of calculations that drive analytics. The associative engine 170 may use logical inference before any calculations occur to determine which data is relevant to current selections. This logical inference may happen virtually instantaneously because there is no number crunching involved, just logical evaluation of relationships. Once logical inference determines the relevant data set, calculation engines (e.g., processing engine 212 shown in FIG. 2A) may compute analytics in real-time using advanced techniques including hypercubes and multithreading.

The associative engine 170 may excel in artificial intelligence scenarios because context retention may allow AI agents (e.g., global assistants 186, custom assistants 188, or contextual assistants 190 of the architecture 180 shown in FIG. 1C) to build complex reasoning chains, high-speed calculation may support rapid hypothesis testing, complete data access may ensure AI models (e.g., the ML module 102A shown in FIG. 1A) have full information, relationship visibility may help AI understand data connections, and governed calculations may provide trustworthy results for automated decisions. The associative engine 170 may retain context across multiple questions 162, refining and recontextualizing after every interaction.

The technical improvements provided by the associative engine 170 may address specific technical problems in the field of data analytics. Traditional analytics tools may create tunnel vision where a user 153 writes a query, gets a result set, and sees only what matches specific criteria, while everything else including context, relationships, and the broader story disappears. Traditional approaches may result in data being left behind because SQL joins force selection of primary and secondary data sources, exploration being restricted to pre-built reports and dashboards, questions 162 needing to be anticipated in advance making discovery nearly impossible, performance suffering because each new question requires hitting the database again, and context being lost because related information does not stay connected. The associative engine 170 may provide a technical solution to these technical problems by maintaining global context across an entire application, performing deterministic calculations that are traceable and reproducible, and enabling exploration without requiring predefined queries or reports. The in-memory data structures, bit-stuffed pointers, state vectors, and hypercube calculations described herein represent specific technical implementations that improve the functioning of computer systems (e.g., the computing device 102 of the system 100 shown in FIG. 1A) for data analytics.

In some aspects, the system 150 may be utilized to transform both structured and unstructured enterprise content into machine-consumable representations. Structured content may include analytics applications, dashboards, business logic, logical models, master measures, master dimensions, field descriptions, bookmarks, stories, expressions, reusable visual assets, security rules, application metadata, data models, and semantic objects associated with one or more analytical applications. Unstructured content may include documents, presentations, HTML files, text files, portable document format files, mail archives, transcripts, tickets, knowledge articles, support records, code repositories, media transcripts, and other file-based content.

The data 152 may be split into manageable chunks in a data conversion process 154. At step 154A, the data 152 may be copied, linked, or otherwise registered for indexing. Source content may be registered without requiring the entire underlying source content to be persisted in the same environment as the assistant application 158. Source materials may be refreshed manually, on a schedule, based on deltas, in response to events, or according to other synchronization policies. At step 154B, the data 152 may be split into chunks (e.g., portions of text data). Chunking may be performed differently for different source types. A document may be segmented by sentence, paragraph, heading, or semantic boundary. A transcript may be segmented by speaker turn or time interval. An analytical application may be segmented according to measures, dimensions, master items, dashboard objects, sheets, or semantic objects. A load script or expression may be segmented according to script block, transformation step, or expression boundary. Chunk sizes may vary according to complexity, token budget, expected retrieval granularity, or computational resources.

Once the data is split into chunks, each chunk may be converted into an embedding at step 154C. Embeddings may be created using one or more machine-learning models, such as large language models, transformer models, recurrent neural networks, convolutional neural networks, sentence-embedding models, multimodal models, autoencoders, or dimensionality-reduction methods. Different embedding models may be used for different source types. The system 150 may generate separate representations for raw source text, curated master items, synonyms, descriptions, and logical-model entities, and may assign different weights to such representations during subsequent retrieval. For example, embeddings associated with curated master items may be weighted more heavily than embeddings associated with raw source text during retrieval operations.

In some examples, at step 154C, each chunk may be converted into an embedding via LLM 160 in FIG. 1B (e.g., resident at and/or within the control of the ML module 102A). Each embedding may comprise a numerical representation of the corresponding chunk of the data 152 that may be consumed/used by an LLM(s) (e.g., by the LLM 160). Traditional word embedding models like Word2Vec, GloVe (Global Vectors for Word Representation), or FastText can also be used to generate vector representations of words or phrases. The choice of model depends on factors such as the nature of the data, the specific requirements of the task, and the available computational resources.

At step 154D, the embeddings may be stored in a vector database 156 (e.g., resident at and/or controlled by any of the data stores 106, 108, 110). The vector database 156 may semantically index the content and maintain references back to original sources. The vector database 156 may store metadata such as access permissions, source type, source timestamp, indexed date, tenant or workspace identifier, application identifier, object identifier, semantic tags, or ranking weights. The vector database 156 may be used in combination with a re-ranking service, a keyword index, a graph traversal engine, or a rules engine to improve retrieval quality.

In some aspects, the system 150 may maintain separate or partially separate indexes for structured and unstructured data while still supporting hybrid retrieval. A structured-application index may emphasize business logic, measures, dimensions, master items, and visual objects. An unstructured knowledge-base index may emphasize document passages, article fragments, ticket histories, or transcript excerpts. In response to a given question, the system 150 may retrieve from one index, the other index, or both, and may merge or reconcile the resulting context based on confidence, permissions, ranking scores, or answerability criteria. Curated semantic artifacts such as master measures, master dimensions, or business-logic entities may be weighted more heavily than raw source fields during question interpretation or result ranking to reduce ambiguity and increase answer fidelity. As used herein, a master measure may refer to a reusable, governed calculation expression that defines a specific metric, such as total sales, average order value, or profit margin, and that may be centrally managed to ensure consistent interpretation across applications and users. As used herein, a master dimension may refer to a reusable, governed field or attribute that defines a category for grouping or filtering data, such as product category, region, time period, or customer segment, and that may be centrally managed to ensure consistent interpretation across applications and users. As used herein, a business-logic entity may refer to a semantic object that encapsulates domain-specific rules, relationships, or constraints, such as a customer classification rule, a pricing tier definition, or a sales territory assignment, and that may be used to interpret user queries in accordance with organizational conventions.

After embeddings are generated and semantically indexed in the vector database 156, an assistant application 158 (e.g., resident at and/or controlled by any of the servers 106B, 108B, 110B), such as a natural language (“NL”) assistant, agent, and/or a chatbot, may provide answers to queries related to the data 152. The assistant application 158 may interact with the LLM 160 to process natural language queries from one or more users 153. The system 150 may further support predictive services, anomaly-detection services, or proactive discovery services. For example, the assistant application 158 may request a real-time predictive score, a forecast, or a feature-importance explanation from a predictive model. A predictive output may comprise a classification, a regression result, a time-series forecast, an anomaly indication, a feature-importance explanation, a contribution score, a SHAP-like explanation, a what-if scenario analysis, or real-time prediction results.

As shown in FIG. 1B, the one or more users 153 may send a question 162 (e.g., a NL query) to the assistant application 158. The assistant application 158 may perform a search 162 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app’s capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

A data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150’s process, so details on user roles and their associated permissions may be included. The system 150 may enforce row-level, column-level, object-level, or application-level permissions. The system 150 may apply space-based or tenant-based access rules. The system 150 may filter outputs according to role or entitlement. The system 150 may log provenance and lineage. The system 150 may sanitize secrets and personally identifiable information. The system 150 may detect or reject prompt-injection attempts. The system 150 may constrain model invocation according to processing-location policies. The system 150 may prevent the assistant application 158 from surfacing source material not authorized for the requesting user.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create – and maintain – robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user’s 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user’s 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user’s 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

The system 150 shown in FIG. 1B may be capable of triggering actions and automated processes based on insights derived from user queries. In some cases, the assistant application 158 may analyze the natural language question 162 and the generated answer 168 to identify potential actions. The assistant application 158 may then initiate these actions through appropriate components of the system 150 or external systems. For example, if a natural language question 162 relates to a specific data trend, the system 150 may not only provide an answer 168 describing the trend but may also trigger an automated process to generate a detailed report or alert relevant stakeholders. In some cases, these automated processes may be executed by components within the global assistants 186 or custom assistants 188 of the architecture 180. These action triggering and automated process capabilities are further detailed herein. The interaction between the users 153, the assistant application 158, and the large language model 160 may be iterative. In some cases, the system 150 may engage in a multi-turn conversation with the users 153, refining and expanding upon the initial natural language question 162 and answer 168. This iterative process may allow for more comprehensive and accurate responses to complex queries.

Referring to FIG. 1C, an architecture 180 may implement the functionality of the system 150 shown in FIG. 1B. The architecture 180 may comprise a multi-tiered assistant system. The multi-tiered assistant system may also operate as an agentic environment in which one or more of the assistants function as autonomous agents capable of independently executing tasks, coordinating with other agents, and initiating actions without requiring explicit user direction for each step. The multi-tiered assistant system may process queries from a client device. The client device may correspond to the computing device 102 shown in FIG. 1A, which may comprise the ML module 102A. The client device may communicate with a supervisor 182. The supervisor 182 may be responsible for receiving and analyzing user queries. The supervisor 182 may serve as an initial point of contact for user queries. The supervisor 182 may receive queries from various user interfaces or input methods.

The supervisor 182 may perform intent recognition. The intent recognition may comprise analyzing the content and context of a user’s query to determine the underlying intent or purpose. The supervisor 182 may extract query intent beyond the literal text of the query. The supervisor 182 may identify implicit requirements, constraints, and desired outcomes. The supervisor 182 may classify queries into functional categories. The functional categories may include analytical, administrative, help-seeking, or action-requesting categories. The supervisor 182 may classify queries along multiple dimensions. The multiple dimensions may include a functional intent, a domain context, data requirements, an execution profile for single or multi-agent execution, and a complexity level.

With continued reference to FIG. 1C, the supervisor 182 may be in communication with a router 184. The router 184 may direct queries to appropriate assistants based on determined intent. The supervisor 182 and the router 184 may work in conjunction to process and route user queries efficiently. The router 184 may maintain a registry of all available assistants at a global assistants tier. Each assistant may be described by functional capabilities and specializations, use cases and recommended query types, domain applicability, required data sources and integrations, and semantic descriptions for matching.

The router 184 may use the intent information to determine which specific assistant or module within the architecture 180 is best suited to handle the user’s query. The router 184 may perform semantic matching of query intent to assistant capabilities. The router 184 may perform adaptive routing comprising routing adjustments made based on interim results during query execution. The adaptive routing may support agentic behavior by enabling agents to dynamically delegate subtasks to other agents, request additional context, or invoke downstream services autonomously based on interim results. The router 184 may be in communication with global assistants 186. The global assistants 186 may comprise a set of platform-level assistants that process and respond to various types of user queries.

The global assistants 186 may include a cross assistant 186A configured to handle queries requiring coordination between multiple specialized assistants. The global assistants 186 may include a platform assistant 186B configured to handle platform-specific actions. The platform assistant 186B may communicate with the assistant application 158 shown in FIG. 1B to execute platform-specific actions. The global assistants 186 may include a help assistant 186C configured to provide assistance with product documentation and usage. The help assistant 186C may access the vector database 156 shown in FIG. 1B to retrieve relevant documentation for user queries. The global assistants 186 may include a global assistant N 186D representing additional extensible assistants.

The global assistants 186 may include an analytics agent that queries applications and underlying data models. The analytics agent may access pre-curated, governed data models with metrics, dimensions, and KPIs. The analytics agent may leverage the associative engine 170 shown in FIG. 1B or the AE module 102B shown in FIG. 1A directly, rather than relying on text-to-SQL translation. The analytics agent may interact with the vector database 156 shown in FIG. 1B and the large language model 160 to generate insights and visualizations based on user queries. The global assistants 186 may include an automation agent that executes workflows and query processes. The global assistants 186 may include productivity agents that embed contextual assistance within user workflows. One or more of the global assistants 186 may operate as autonomous agents within the agentic environment of the architecture 180. For example, the analytics agent may autonomously determine which data models to query, which visualizations to generate, and which explanations to produce without requiring step-by-step user direction. The automation agent may autonomously execute workflows, trigger system integrations, and invoke API calls to external systems based on detected conditions or analytical results.

As further shown in FIG. 1C, the architecture 180 may include custom assistants 188. The custom assistants 188 may be user-created assistants designed for specialized tasks. The custom assistants 188 may include an assistant 1 188A and an assistant N 188N. The custom assistants 188 may be built through UI-based configuration combining knowledge 188B, apps 188C, and actions 188D. The knowledge 188B may represent knowledge bases containing unstructured data sources. The apps 188C may represent linked analytics applications containing structured data through pre-built data models. The actions 188D may represent automation workflows triggered based on query results. The custom assistants 188 may operate as autonomous agents within the agentic environment of the architecture 180. For example, a custom assistant 188 may autonomously retrieve information from multiple knowledge bases, correlate data across linked analytics applications, and initiate automation workflows based on query results.

With continued reference to FIG. 1C, the architecture 180 may include contextual assistants 190. The contextual assistants 190 may be domain-specific assistants tailored to particular contexts. The contextual assistants 190 may also operate as autonomous agents within the agentic environment of the architecture 180, independently executing domain-specific tasks such as data preparation, machine learning model training, glossary management, or role-based assistance. The contextual assistants 190 may include a data prep 190A assistant configured for data preparation tasks, an AutoML 190B assistant configured for machine learning task assistance, a glossary 190C assistant configured for terminology and definitions, a data product 190D assistant configured for data product related queries, a role-based 190E assistant configured for role-specific assistance, and an assistant N 190N representing additional contextual assistants.

The global assistants 186 may be in communication with both the custom assistants 188 and the contextual assistants 190. Queries may be routed from platform-level assistants to more specialized assistants based on the nature of the query. The hierarchical arrangement may allow the architecture 180 to process queries through multiple tiers. The supervisor 182 and router 184 may direct queries to appropriate global assistants 186. The global assistants 186 may utilize custom assistants 188 or contextual assistants 190 to generate comprehensive responses.

FIGS. 2A-2C illustrate processing flows implemented by the systems of FIGS. 1A and 1B for handling natural-language queries using multiple coordinated services and agents. The processing flows may be executed by the computing device 102 and ML module 102A of system 100 (FIG. 1A) in communication with the assistant application 158, LLM 160, and vector database 156 of system 150 (FIG. 1B). The processing flows illustrate how a user 153 interacts with the systems to generate responses to natural-language queries.

Referring to FIG. 2A, a processing flow 200 depicts the architecture 180 implemented across the systems of FIGS. 1A and 1B. The user 153 may interact with an assistant interface 202 through an assistant API. The assistant interface 202 may be executed by the computing device 102 and may comprise a native application interface, a web-based interface, an embedded chat interface, a mobile interface, or another user-facing surface configured to submit questions and display answers. The assistant interface 202 may operate as an agentic chat interface that can answer questions from both structured analytical applications and unstructured knowledge bases stored in the data stores 106, 108, 110 of system 100.

The assistant interface 202 may communicate with an analysis agent 204 executing on the computing device 102. The analysis agent 204 may orchestrate multiple services and determine how to process a given question. The analysis agent 204 may correspond to one of the global assistants 186 or contextual assistants 190 of the architecture 180 shown in FIG. 1C. The analysis agent 204 may be associated with a service-kit sidecar 204A that supplies app metadata, recommendation data, or other supporting information from the data stores 106, 108, 110. In some configurations, the functions of the service-kit sidecar 204A may be performed by the analysis agent 204 itself and/or by the assistant interface 202. For example, the analysis agent 204 may retrieve app metadata and recommendation data directly from the data stores 106, 108, 110 without a separate sidecar component. In some configurations, the assistant interface 202 may supply supporting information to the analysis agent 204 based on the user's session context, application state, or prior interactions. The analysis agent 204 may identify whether a question is primarily structured, primarily unstructured, hybrid, predictive, or operational in nature, and may classify whether the question is a new question, a follow-up question, a chart-change request, a filter-change request, or an action request.

The analysis agent 204 may communicate with the LLM 160 of system 150 through an LLM Gateway. The LLM Gateway may correspond to the supervisor 182 and router 184 of the architecture 180 shown in FIG. 1C. The LLM Gateway may manage prompts, policies, routing among models, model-specific token limits, safety checks, output formatting, and audit logging. The LLM 160 may be used for natural-language understanding, paraphrasing, query-to-semantic translation, explanation generation, narrative answer generation, summarization of retrieved context, follow-up suggestion generation, or chart-specification generation.

The analysis agent 204 may also communicate with a natural-language broker 206 executing on the computing device 102. The natural-language broker 206 may parse the user’s submission and identify entities, measures, dimensions, temporal constraints, comparative phrases, ranking requests, or requested visualization types. The natural-language broker 206 may normalize the question into one or more intermediate representations and may interact with domain-specific vocabulary, business glossaries, or logical models stored in the data stores 106, 108, 110 to resolve enterprise-specific terminology in a governed manner.

A natural-language application-search service 208 may receive app metadata from the analysis agent 204 and perform search operations against structured analytical applications stored in the data stores 106, 108, 110 and unstructured knowledge bases in the vector database 156. The natural-language application-search service 208 may communicate with the LLM 160 through an API and may include a semantic search agent that identifies relevant master items, measures, dimensions, or application objects, a knowledge-base agent that performs semantic search over vector indexes of unstructured content, a re-ranking component that refines candidate results, and a retrieval manager that merges hybrid results according to confidence, freshness, permissions, or intent.

In some aspects, the natural-language application-search service 208 may compare one or more terms of the current question 162 against vectorized profiles of a plurality of analytical applications (e.g., the apps 188C shown in FIG. 1C) to identify at least one analytical application from among the plurality without requiring prior user selection of the application. The vectorized profiles may be stored in the vector database 156. Each vectorized application profile may comprise embeddings derived from metadata, semantic objects, synonyms, measures, dimensions, and business-logic entities of a respective analytical application. The natural-language application-search service 208 may break the current question 162 into vectors and compare the vectors against the vector store consisting of multiple analytical applications accessible within a customer environment. This cross-application routing may enable the system 150 to automatically identify relevant applications based on the content of the user’s 153 question rather than requiring the user 153 to explicitly select an application before submitting a query.

The natural-language application-search service 208 may provide classification information to a data processing service 210 executing on the computing device 102. The data processing service 210 may access classifications bundles 210A, analysis recommendation bundles 210B, and business model 210C metadata from the data stores 106, 108, 110 to generate identifies relevant measures, dimensions, filters, aggregations, chart candidates, source passages, answer cards, action recommendations, or predictive requests.

In some aspects, the data processing service 210 may classify, prior to invoking the LLM 160, the current question 162 into one or more analysis types. The one or more analysis types may comprise at least one of a forecasting analysis, a clustering analysis, a ranking analysis, a comparative analysis, or an aggregation analysis. The classification may be performed before the LLM 160 is invoked such that the retrieval query and visualization (e.g., the rendered payload 214 shown in FIG. 2B) are generated based at least in part on the classified analysis type. This pre-LLM classification may guide the LLM 160 to perform specific types of analyses rather than generating irrelevant or inappropriate answers 168 or visualizations. The data processing service 210 may segment the current question 162 into an analysis type and provide direction to downstream processing components (e.g., the processing engine 212) based on the classified analysis type. The classifications bundles 210A may store classification rules, patterns, or models used to classify questions into analysis types.

The data processing service 210 may communicate with a processing engine 212 through an API. The processing engine 212, which may be implemented by the ML module 102A and/or the associative engine 170 of the system 150 (or the AE module 102B of the computing device 102) may generate a chart specification, a table specification, a sheet layout, an answer card, an explanation card, a source-detail card, an action widget, or combinations thereof. The processing engine 212 may be configured to produce outputs suitable for rendering within a governed analytics application or in an external client via a programming interface.

Referring to FIG. 2B, a processing flow is depicted in which the processing engine 212 produces, through an API, a rendered payload 214 comprising a sheet, one or more visualizations, and a description. This use case may be appropriate when the user’s question can be answered primarily through a structured analytical visualization and accompanying description generated from data stored in the data stores 106, 108, 110 and processed by the computing device 102. The processing engine 212 may leverage the associative engine 170 to perform in-memory calculations, aggregations, and filter operations when generating the rendered payload 214. For example, the processing engine 212 may comprise and/or be in communication with the associative engine 170

Referring to FIG. 2C, an alternative processing flow is depicted in which the processing engine 212 first produces a response payload 213 using supplemented templates 203 from the LLM 160 and request metadata. The response payload 213 may include narrative answer text, retrieved evidence, an answer skeleton, template selections, metadata or presets, or object specifications. The response payload 213 may then be processed based on user selections 205, allowing a user to select from a variety of responses for a suitable dashboard, resulting in a rendered payload 214 comprising a sheet, visualizations, and description.

The use case of FIG. 2C may be useful for smart-sheet generation, guided analytical workflows, or embedded assistant experiences implemented by the assistant application 158 of system 150. The system may generate a summary card, a trend chart, a supporting table, an explanatory note, and an action control on a single sheet. The user 153 may accept, refine, or reject one or more objects before publication. Generated objects may be persisted as analytical artifacts in the data stores 106, 108, 110 and may be re-used in later sessions or surfaced to other authorized users.

The process flows shown in FIGS. 2A-2C may be implemented using named assistants/agents or unnamed processing services distributed across the computing device 102, ML module 102A, and network 104 of system 100, in coordination with the assistant application 158, LLM 160, and vector database 156 of system 150. The process flows shown in FIGS. 2A-2C may be implemented by the architecture 180 of FIG. 1C, with the supervisor 182 and router 184 directing queries to the global assistants 186, custom assistants 188, or contextual assistants 190. Such components may be embodied as microservices, workflows, serverless functions, library modules, containers, or combinations thereof. The illustrated architecture is exemplary rather than limiting.

For example, a user may submit a natural-language question through the assistant interface 202. The supervisor 182 may receive the question and perform intent recognition to classify the question as an analytical query. The supervisor 182 may pass intent information to the router 184. The router 184 may perform semantic matching to determine that the analytics agent within the global assistants 186 is best suited to handle the query. The router 184 may direct the query to the analytics agent. The analytics agent may access the vector database 156 to retrieve relevant context and may interact with the LLM 160 to generate a visualization and mapping explanation. The analytics agent may return the response to the assistant interface 202 for presentation to the user. In some cases, the router 184 may determine that a custom assistant 188 or contextual assistant 190 is better suited to handle a specialized query, and may route the query accordingly. Other examples are possible as well.

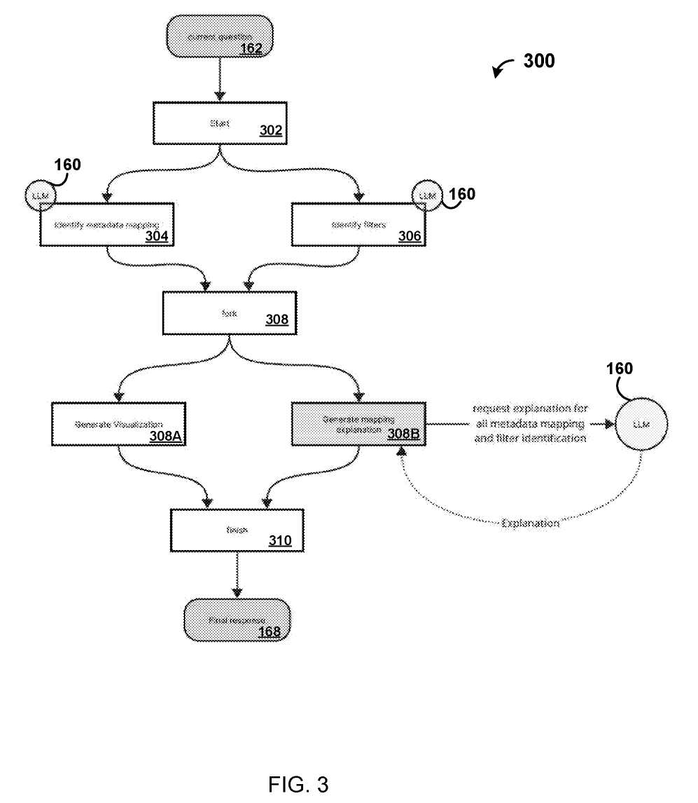

Referring to FIG. 3, a processing flow 300 for processing natural-language queries and generating responses may be implemented by the system 100 and the system 150. The processing flow 300 may begin with a current question 162 received at step 302. The current question 162 may comprise user input and may correspond to a new user request or may correspond to a context-aware follow-up request. The computing device 102 may receive the current question 162 through the network 104 from a user interface or assistant application.

From step 302, the processing flow 300 may branch into multiple paths. One path may proceed to step 304, where the system may identify metadata mapping information. Another path may proceed to step 306, where the system may identify filter information. These processes at step 304 and step 306 may occur in parallel, serially, or iteratively. The computing device 102 may execute both processes using the ML module 102A in coordination with data retrieved from the data stores 106, 108, 110.

The metadata mapping information determined at step 304 may map one or more terms of the current question 162 to one or more semantic objects of at least one analytical application and at least one knowledge base. The metadata mapping information may identify which terms in the current question 162 correspond to measures, dimensions, entities, semantic business objects, master items, application objects, knowledge-base topics, or workflow actions. The system may rank candidate mappings and retain multiple alternatives for later explanation or confidence scoring. Determining the metadata mapping information may comprise resolving at least one term of the current question 162 using at least one of a logical model, business logic, a business glossary, a synonym list, a master item, or a description associated with the at least one analytical application.

The filter information determined at step 306 may identify temporal ranges, categories, locations, thresholds, comparison groups, segment definitions, ranked subsets, or action constraints. Determining the filter information may comprise determining at least one of a temporal filter, a categorical filter, a geographical filter, a threshold filter, a ranking filter, or a comparison filter based on the current question 162. The filters may be explicit or implicit. For example, “this quarter” may imply a date range, “for Amazon” may imply a store-type dimension value, “top five” may imply a ranking and limit, “low in stock” may imply a threshold, and “next month” may imply a forecast horizon or unsupported predictive request. The LLM 160 may be utilized in connection with step 304 and step 306 to assist in determining the metadata mapping information and the filter information. As an example, the assistant application 158 may coordinate with the LLM 160 to process the current question 162 and generate the appropriate mappings and filters.

The paths from step 304 and step 306 may converge at step 308, where the processing flow 300 may reach a fork or decision point. Based on the metadata mapping information and the filter information, the system may generate a retrieval query. The retrieval query may identify the one or more semantic objects and may incorporate the filter information. The system may receive context from the at least one analytical application and the at least one knowledge base based on the retrieval query. Receiving the context may comprise receiving structured context from the at least one analytical application and receiving unstructured context from the at least one knowledge base. Receiving the structured context may comprise receiving at least one of a measure or a dimension from the at least one analytical application. Receiving the unstructured context may comprise receiving at least one embedding from a vector database storing embeddings associated with document content.

Step 308 may determine whether to generate a visualization, a narrative response, a hybrid response, a mapping explanation, a source-detail panel, a follow-up action, or combinations thereof. One branch from step 308 may lead to step 308A for generating a visualization. Another branch from step 308 may lead to step 308B for generating a mapping explanation.

At step 308A, the system may generate a visualization based on the metadata mapping information, the filter information, and the context. The visualization may represent data associated with the one or more semantic objects. The visualization may comprise a chart type, a measure, one or more dimensions, one or more filters, grouping or ranking logic, formatting, titles, explanations, and controls. The chart type may be selected by user request, inferred from the analysis goal, selected from a template, or chosen through a recommendation model. Other examples are possible as well.

At step 308B, the system may generate a mapping explanation based on the one or more terms, the metadata mapping information, and the filter information. The LLM 160 may be utilized in connection with step 308B to request an explanation of the metadata mappings and filters. Generating the mapping explanation may comprise generating an identification of how at least a portion of the current question 162 was interpreted, which of the one or more semantic objects were selected, which filters were applied based on the filter information, and which sources were used to generate a final response 168. The mapping explanation may identify how particular words or phrases in the user’s question were interpreted, which semantic objects, fields, or master items were selected, which filters were applied, which sources or applications were consulted, how retrieved evidence was ranked or reconciled, what calculations, aggregations, forecasts, or transformations were performed, any assumptions, constraints, or confidence considerations, and whether any answer components are inferred, predicted, or unavailable. Other examples are possible as well.

The paths from step 308A and step 308B may converge at step 310, where the processing flow 300 may finish. At step 310, the system may cause the final response 168 to be output. The final response 168 may comprise the visualization and the mapping explanation. The final response 168 may include one or more of a natural-language answer, a chart, a sheet, a key performance indicator, a source citation, a source-detail panel, an explanation card, a confidence indicator, a review marker, a feedback control, or a suggested follow-up action. The final response 168 may further comprise at least one of a source citation, a source-detail control, an answer breakdown by source, a confidence indication, or a feedback control. The final response 168 may further include a control for viewing sources, a control for saving the answer, a control for adding the answer to a sheet, or a control for initiating a follow-up workflow.

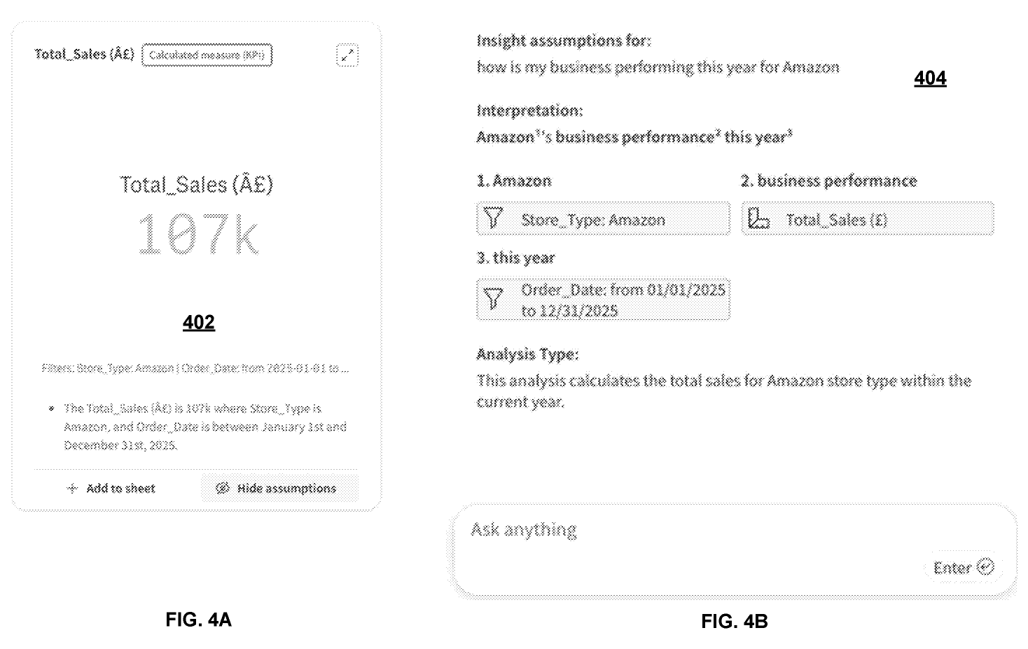

Referring to FIGS. 4A-4B, an answer interface 402 and an explanation interface 404 may be provided to display analytical results and corresponding explanations. The answer interface 402 may display calculated measures with filter indicators based on natural language queries processed by the system 100 or system 150. The answer interface 402 may present a calculated measure(s), such as Total_Sales with an associated value. The answer interface 402 may include filter indicators showing applied constraints such as Store_Type and Order_Date parameters. For example, the answer interface 402 may display that the Store_Type corresponds to Amazon and the Order_Date ranges from January 1, 2025 to December 31, 2025. The answer interface 402 may further include controls for adding the answer to a sheet and for hiding assumptions.

The explanation interface 404 may present insight assumptions showing how a current question was interpreted by the system 100 and/or system 150. The explanation interface 404 may receive user input comprising a current question from a user device. The computing device 102 and/or the analysis agent 204 may determine metadata mapping information based on the current question. The metadata mapping information may map one or more terms of the current question to one or more semantic objects of at least one analytical application and at least one knowledge base.

The explanation interface 404 may display mappings for store type parameters. For example, the explanation interface 404 may identify that the term “Amazon” in the current question corresponds to a Store_Type filter. The explanation interface 404 may show business performance measures by mapping terms such as “business performance” to specific measures like Total_Sales. The explanation interface 404 may present date ranges by interpreting temporal terms such as “this year” as corresponding to specific Order_Date filters from a start date to an end date.

The computing device 102 and/or the analysis agent 204 may determine filter information based on the current question. The filter information may identify temporal constraints, categorical constraints, or other parameters derived from the natural language input. The computing device 102 and/or the analysis agent 204 may generate a retrieval query based on the metadata mapping information and the filter information. The retrieval query may identify the one or more semantic objects and may incorporate the filter information.

The computing device 102 and/or the analysis agent 204 may receive context from the at least one analytical application and the at least one knowledge base based on the retrieval query. The computing device 102 and/or the analysis agent 204 may generate a visualization based on the metadata mapping information, the filter information, and the context. The visualization may represent data associated with the one or more semantic objects. The computing device 102 and/or the analysis agent 204 may generate a mapping explanation based on the one or more terms, the metadata mapping information, and the filter information. The mapping explanation may identify how at least a portion of the current question was interpreted.

The computing device 102 and/or the analysis agent 204 may be configured to at least output (cause display of) a response through the answer interface 402 and the explanation interface 404. The explanation interface 404 may include an analysis type section indicating the type of calculation performed, such as total sales calculations for a specified store type within a defined time period. Other examples are possible as well.

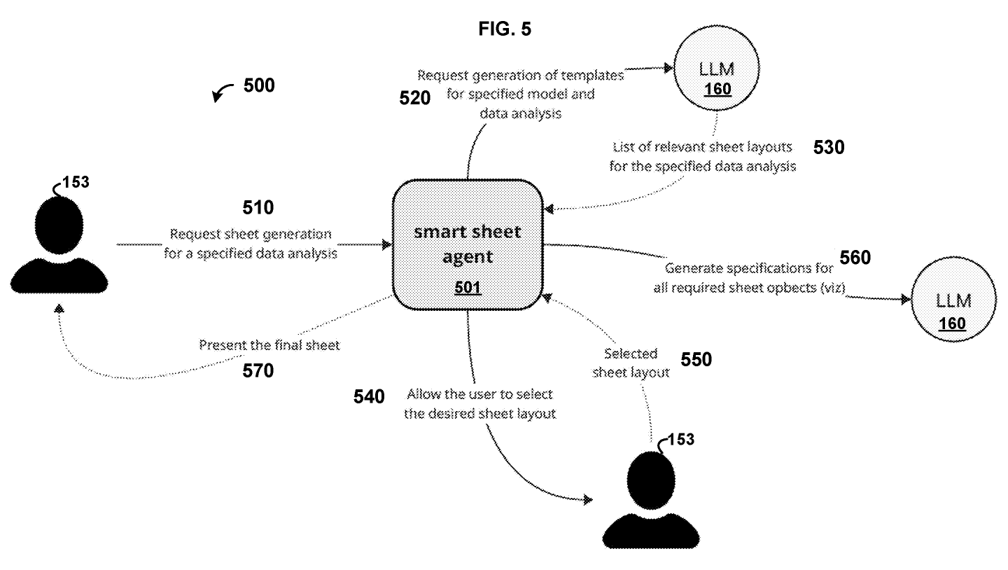

Referring to FIG. 5, a processing flow 500 for generating smart sheets using a smart sheet agent 501 is shown. The smart sheet agent 501 may be implemented as a custom assistant 188, a global assistant 186, or a contextual assistant 190 within the architecture 180 shown in FIG. 1C. The architecture 180 may be utilized by the system 150 to route queries, prompts, and other inputs from the user 153 to the smart sheet agent 501 for processing. The processing flow 500 may demonstrate interactions between a user 153, the smart sheet agent 501, and an LLM 160 to create analytical sheets based on natural language requests.

The processing flow 500 may begin at step 510 where a sheet generation request may be received. For example, at step 510, the user 153 may send a request for sheet generation for a specified data analysis. The supervisor 182 of the architecture 180 may receive the request and perform intent recognition to classify the request as a sheet generation request. Based on the classification, the router 184 of the architecture 180 may route the request to the smart sheet agent 501. The request may arise from a direct user interaction, a follow-up conversation, an automation, or an external assistant interface.

Following step 510, the processing flow 500 may proceed to step 520 where a request for generation of templates may be received. For example, at step 520, the smart sheet agent 501 may communicate with the LLM 160 to request generation of templates for the specified model and data analysis. The router 184 of the architecture 180 may coordinate communication between the smart sheet agent 501 and the LLM 160. The LLM 160 may generate templates based on historical usage, curated design patterns, policy constraints, domain-specific templates, chart recommendations, or large-language-model suggestions.

The processing flow 500 may continue to step 530 where a list of relevant sheet layouts may be received. For example, at step 530, the smart sheet agent 501 may receive from the LLM 160 a list of relevant sheet layouts for the specified data analysis. The layout selection may account for user role, display form factor, chart legibility, object count, narrative requirements, or required actions. The global assistants 186 of the architecture 180 may assist in evaluating and processing the list of relevant sheet layouts. The contextual assistants 190 of the architecture 180 may provide domain-specific guidance for layout selection.

The processing flow 500 may then proceed to step 540 where the user 153 is provided an option to select a sheet layout. For example, at step 540, the smart sheet agent 501 may allow the user 153 to select a desired sheet layout from the list of relevant sheet layouts. The architecture 180 may present the layout options to the user 153 through the assistant interface managed by the supervisor 182. The user 153 may explicitly select a layout through an interface control or the selection may be implicit based on a verbal request, user preference, device type, or recommendation score. Other examples are possible as well.

At step 550, a selected sheet layout may be received via the user 153. The selected sheet layout may be stored within the architecture 180 for processing by the global assistants 186 or custom assistants 188. The user 153 may iterate among multiple candidate layouts before a final layout is chosen. The processing flow 500 may advance to step 560 where specifications for all required sheet objects may be generated. For example, at step 560, the smart sheet agent 501 may communicate with the LLM 160 to generate specifications for all required sheet objects based on the selected sheet layout. The analytics agent within the global assistants 186 of the architecture 180 may assist in generating specifications for chart types, dimensions, measures, and filters. The contextual assistants 190 of the architecture 180 may provide domain-specific guidance for the specifications. Object specifications may identify chart types, dimensions, measures, filters, explanatory text blocks, source-detail panels, follow-up question controls, action buttons, predictive-score cards, anomaly cards, or other objects. The system may also create reusable analytical artifacts, such as saved chart definitions, reusable insight cards, or sheet objects that can be inserted into an application. Other examples are possible as well.

The processing flow 500 may conclude at step 570 where the final sheet is provided for output. For example, at step 570, the smart sheet agent 501 may provide the final sheet, with all of the required sheet objects generated, for output to the user 153. The architecture 180 may coordinate the rendering and delivery of the final sheet through the supervisor 182 and the assistant application 158. The final sheet may be rendered in a native analytics application, within an assistant experience, or in an external client. The user 153 may save the sheet, add the sheet to an existing application, share the sheet with authorized users, export the sheet, or use the sheet as a starting point for further conversational refinement. Other examples are possible as well.

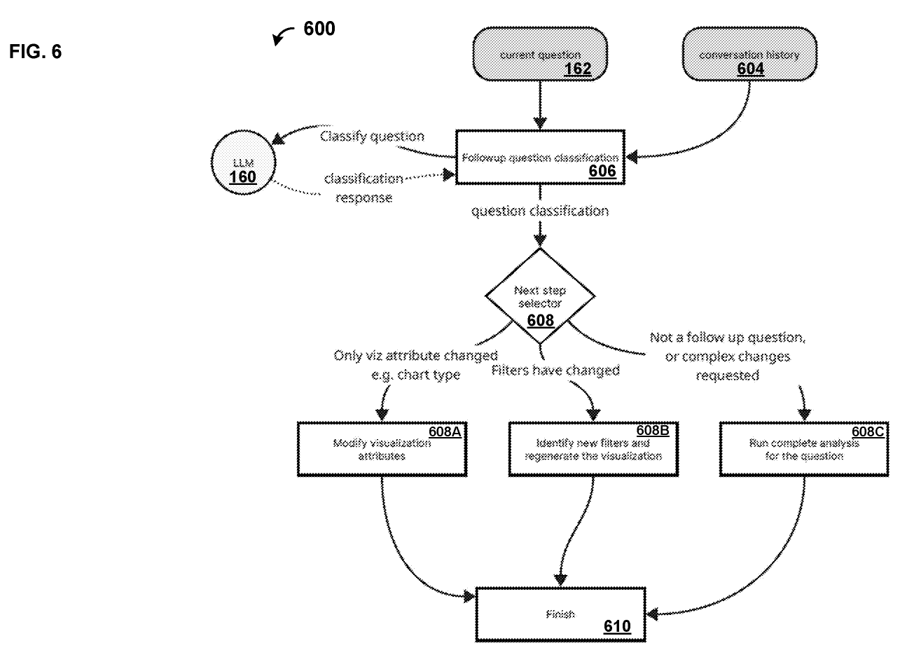

Referring to FIG. 6, a processing flow 600 for processing follow-up questions and generating updated responses is shown. The processing flow 600 may be implemented by the system 100 of FIG. 1A and/or the system 150 of FIG. 1B. For example, the computing device 102 of the system 100 may execute the processing flow 600. The computing device 102 may communicate with the data stores 106, 108, 110 via the network 104 to retrieve and process data during execution of the processing flow 600. The assistant application 158 of the system 150 may also execute the processing flow 600 in conjunction with the LLM 160. The processing flow 600 may also be implemented by the architecture 180 of FIG. 1C, with the supervisor 182 and router 184 coordinating query processing across the global assistants 186, custom assistants 188, or contextual assistants 190.

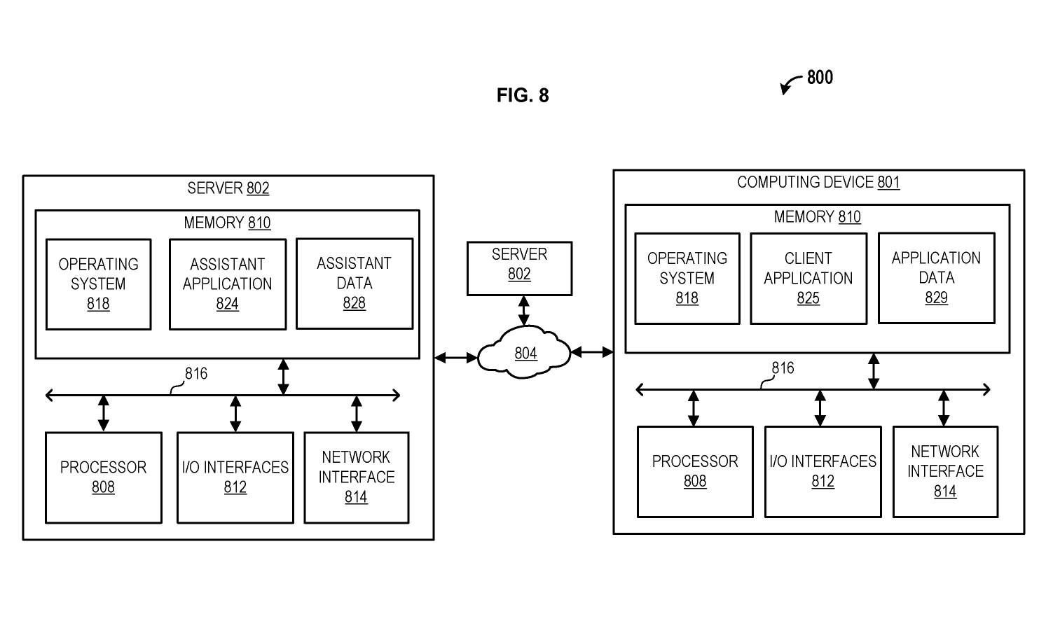

The processing flow 600 begins upon reception of a current question 162 (e.g., submitted by the user 153 via the assistant interface 202 of FIG. 2A and received by the assistant application 158 of FIG. 1B) and a conversation history 604 as inputs. The conversation history 604 may include one or more previous user questions, generated answers, identified mappings, filters, citations, chart specifications, selected layouts, user preferences, saved insights, feedback, review metadata, a combination thereof, and/or the like. The conversation history 604 may be stored in a session store, database, analytics application, or other memory component. For example, the conversation history 604 may be stored in one of the data stores 106, 108, 110 of the system 100, in the vector database 156 of the system 150, or in the memory 810 of the system 800 shown in FIG. 8.

With continued reference to FIG. 6, the processing flow 600 proceeds to a follow-up question classification step 606. The follow-up question classification 606 may be performed by the analysis agent 204 of FIG. 2A in coordination with the natural-language broker 206. The follow-up question classification 606 receives the current question 162 and the conversation history 604. The follow-up question classification 606 communicates with the LLM 160 (e.g., via the LLM Gateway managed by the supervisor 182 and router 184 of FIG. 1C) by sending a classify question request and receiving a classification response. The classification may include determining whether the current question 162 is a follow-up question, whether the follow-up changes only a visualization attribute, whether the follow-up changes one or more filters, whether the follow-up requests an explanation, whether the follow-up asks for a prediction or proactive discovery, or whether the follow-up requests an operational action. The classification response may contain a collection of identified attributes for the current question 162 in relation to the conversation history 604.

Based on the question classification determined at the follow-up question classification 606, the processing flow 600 proceeds to a next step selector 608. The next step selector 608 may be implemented by the router 184 of the architecture 180 shown in FIG. 1C, which performs adaptive routing based on the classification results. The next step selector 608 determines a processing path to follow based on the classification results. The next step selector 608 branches into three possible paths. A first path leads to step 608A when only a visualization attribute has changed. At step 608A, the processing engine 212 of FIG. 2A may modify visualization attributes without re-running an entire analytical pipeline. When the visualization-attribute path is selected, the processing engine 212 may convert a bar chart to a line chart, may add a secondary visualization, may change the number of ranked items displayed, or may generate a sheet from an existing answer. The computing device 102 of the system 100 may perform step 608A by accessing previously computed analytical results stored in the data stores 106, 108, 110. The associative engine 170 of FIG. 1B (or the AE module 102B of FIG. 1A) may provide in-memory calculations to support the visualization modification.

A second path leads to step 608B when filters have changed. At step 608B, the data processing service 210 of FIG. 2A identifies new filters and the processing engine 212 regenerates a visualization or answer using the updated filter information. The assistant application 158 of the system 150 may perform step 608B by querying the vector database 156 with updated filter parameters. The natural-language application-search service 208 of FIG. 2A may perform search operations against the structured analytical applications stored in the data stores 106, 108, 110 using the updated filter information.

A third path leads to step 608C when the current question 162 is not a follow-up question or when complex changes are requested. At step 608C, the system runs a complete analysis for the current question 162 following the processing flow 300 of FIG. 3. The complete analysis may include fresh metadata mapping (step 304), filter identification (step 306), retrieval, and explanation generation (step 308B). The ML module 102A of the computing device 102 may assist in performing step 608C. The global assistants 186 of the architecture 180, including the analytics agent, may be invoked to process the complete analysis.

Each of the three paths from step 608A, step 608B, and step 608C converges at step 610. At step 610, the processing flow 600 finishes by outputting an updated response via the assistant interface 202 of FIG. 2A. The processing engine 212 may generate a rendered payload 214 (as shown in FIGS. 2B-2C) comprising the updated response. The updated response may preserve or restate relevant prior context and may indicate what changed relative to a previous answer.

The system may store the updated question and response in the conversation history 604. The assistant application 158 of FIG. 1B may generate one or more suggested follow-up questions. The automation agent within the global assistants 186 of FIG. 1C may generate one or more suggested actions. The system may capture user feedback or reviewer annotations for later model improvement or governance review. The conversation history 604 may be updated in the data stores 106, 108, 110 of the system 100 or in the memory 810 of the system 800.

As described previously with respect to FIG. 1B, the assistant application 158 may receive the current question 162 from the user 153. The assistant application 158 may also receive follow-up user input comprising a follow-up question via an assistant interface. The assistant interface may correspond to the assistant interface 202 described with respect to FIGS. 2A-2C. Based on the follow-up user input, the assistant application 158 may send the follow-up question to at least one computing device. The at least one computing device may be the computing device 102 of the system 100. The computing device 102 may process the follow-up question using the processing flow 600.

The system may store, based on the current question 162 and the response, the conversation history 604 associated with the current question 162 and the response. The conversation history 604 enables context-aware processing of subsequent questions. A user device (e.g., the computing device 801 of FIG. 8 executing the client application 825) may be configured to receive, via the assistant interface, follow-up user input comprising a follow-up question. The user device may send, based on the follow-up user input, the follow-up question to at least one server device (e.g., the server 804 of FIG. 8 executing the assistant application 824).

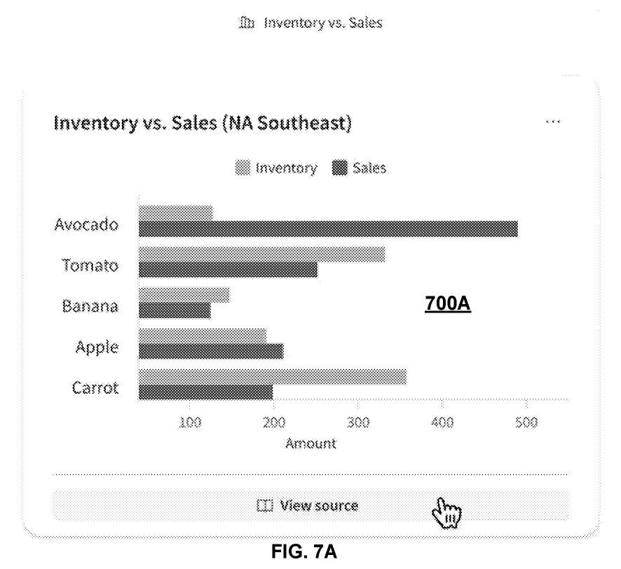

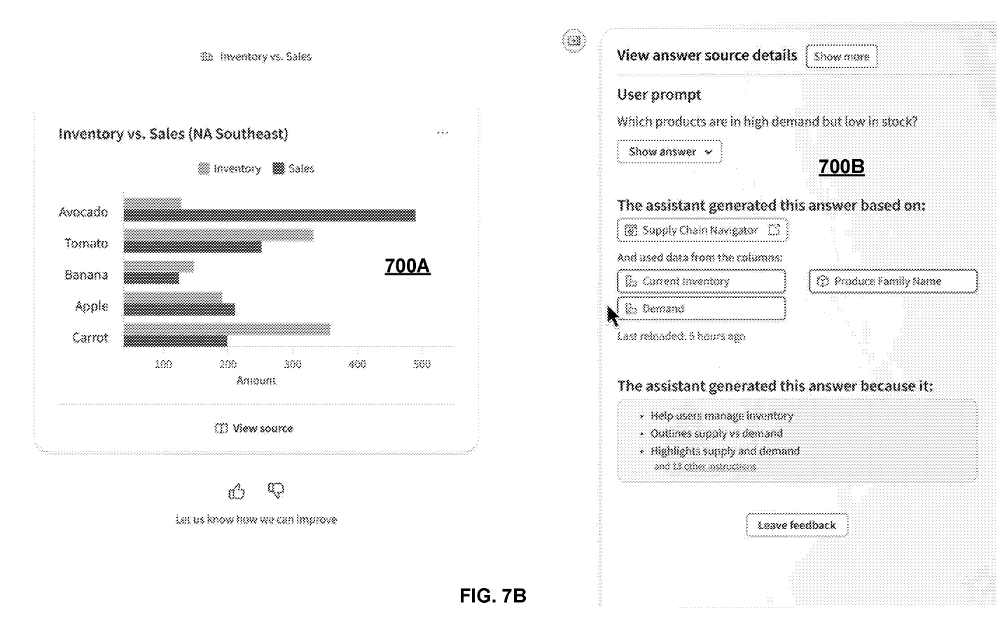

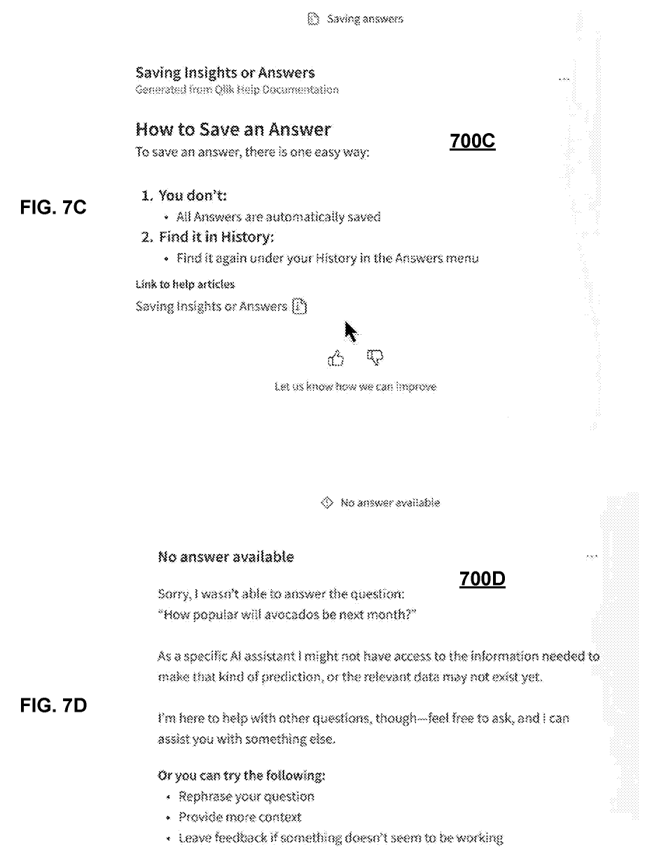

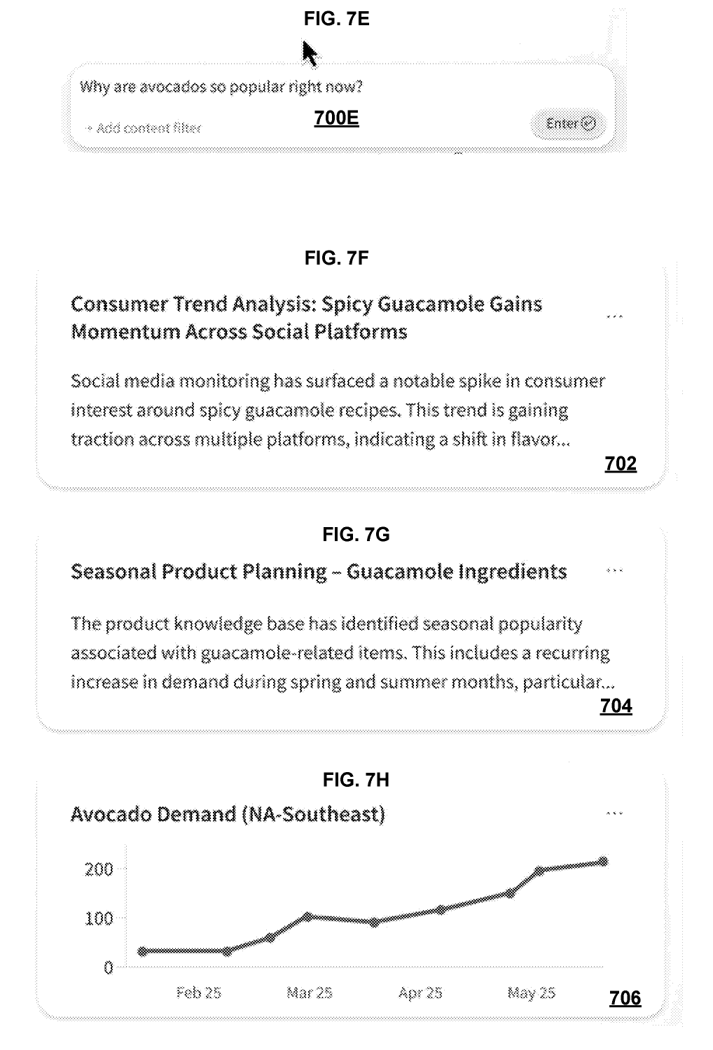

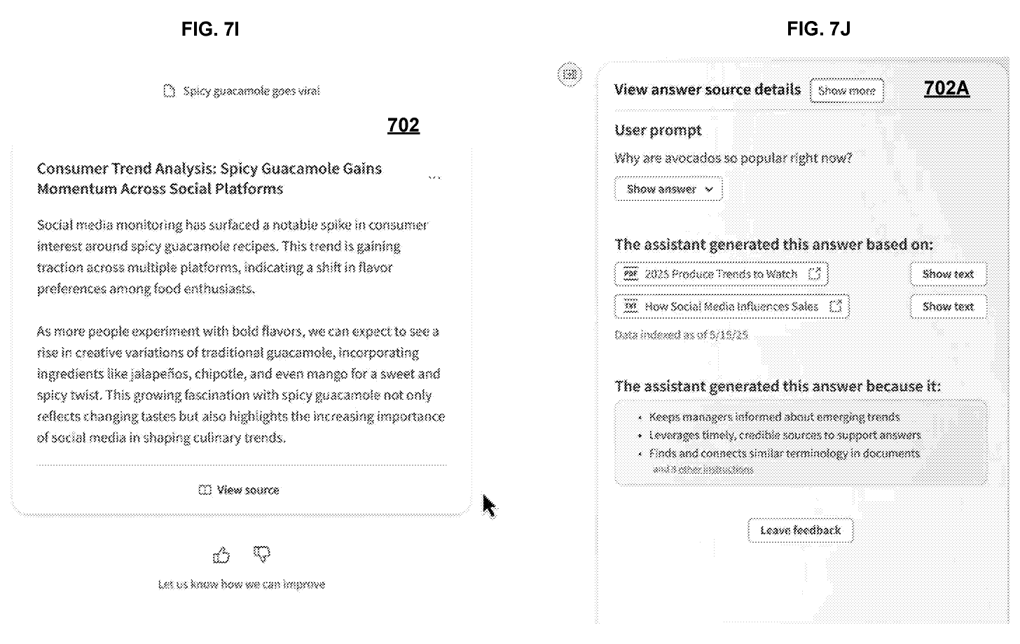

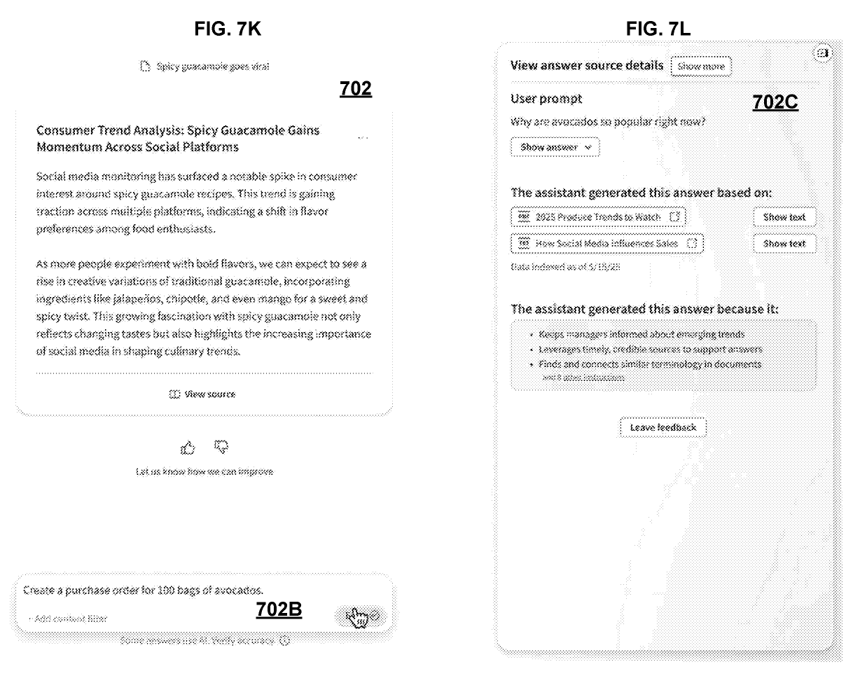

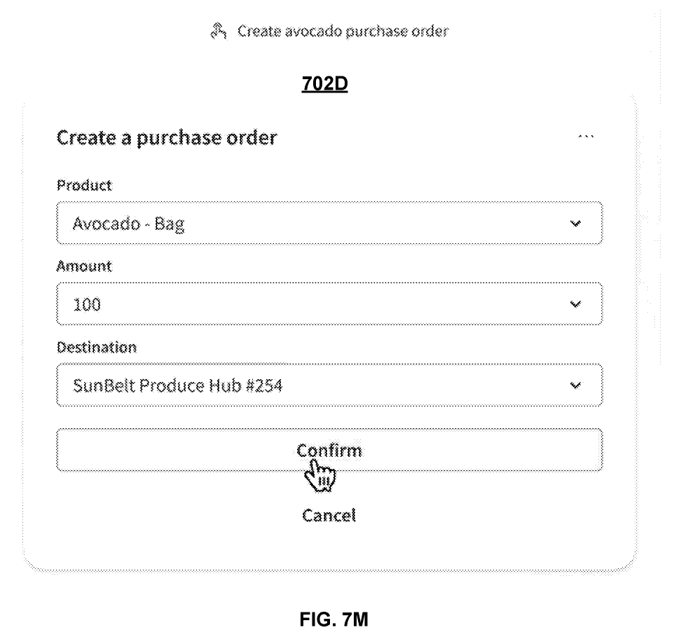

Referring to FIG. 7A, an answer interface 700A may present a visualization comparing inventory and sales data for a geographic region. The answer interface 700A may be generated by the computing device 102 of the system 100 and/or the assistant application 158 of the system 150. The answer interface 700A may display a bar chart comparing measures across multiple categories and may include a View source control for accessing source details and provenance information. The answer interface 700A may be rendered by the processing engine 212 and presented through the assistant interface 202.

The answer interface 700A may be presented together with an explanation interface 700B. The explanation interface 700B may provide source details and provenance for the answer, including the user prompt, the applications from which the answer was generated, the semantic objects used for data retrieval, last reload information, and reasons why the assistant generated the answer. The explanation interface 700B may also include feedback controls. Metadata mapping information may be determined by mapping terms of the current question to semantic objects of at least one analytical application and at least one knowledge base. The mapping explanation displayed in the explanation interface 700B may identify how the current question was interpreted, which semantic objects were selected, which filters were applied, and which sources were used to generate the response.

Referring to FIGS. 7C-7D, an answer-saving interface 700C and an unavailable-answer interface 700D are shown. The answer-saving interface 700C may indicate that answers are automatically saved and provide a pathway for finding saved answers. The unavailable-answer interface 700D may be presented when the system determines that a question cannot be answered with sufficient grounding or confidence. The system may perform safety or quality checks, including requiring answers to be grounded in retrieved sources, scoring confidence, identifying contradictions, and enforcing security rules.

With continued reference to FIGS. 7C-7D, the unavailable-answer interface 700D may be presented when the system determines that a question cannot be answered with sufficient grounding or confidence. The unavailable-answer interface 700D may also be presented when a requested analysis is unsupported. Answer generation may include one or more safety or quality checks. For example, the system may require that a proposed answer be grounded in retrieved sources. The system may compare generated text against source excerpts. The system may withhold or mark answers as unavailable when answerability is insufficient. The system may score confidence. The system may identify contradictions between sources. The system may enforce application security rules. The system may mark portions of an answer as inferred, predicted, or derived.

Referring to FIGS. 7E-7H, a query-entry interface 700E may include a text input field for entering natural-language questions. In response to a question, the system may return multiple coordinated answers from different sources. An answer card 702 may present narrative content generated from unstructured content such as documents or knowledge-base entries. A narrative answer card 704 may present information generated from structured application content. A graphical answer card 706 may present a visualization generated from structured data to provide quantitative context.

Referring to FIGS. 7I-7J, an answer card 702 may present trend-based narrative content with a source-detail panel 702A positioned adjacent. The source-detail panel 702A may display the user prompt, contributing sources with controls for showing source text, indexed dates indicating data freshness, and reasons why the assistant generated the answer. The source-detail panel 702A may include a feedback control for capturing user input regarding answer quality.

Referring to FIGS. 7K-7L, a follow-up action input 702B may be displayed in conjunction with an answer card to allow users to initiate actions based on analytical results. A source-detail and explanation panel 702C may help users verify why an answer was generated before committing to downstream actions. The follow-up action may comprise creating a purchase order, opening a ticket, sending a message, updating a record, triggering an automation, invoking a predictive model, requesting a real-time score, or surfacing a proactive alert.

Referring to FIG. 7M, a purchase order interface 702D may be displayed for creating a purchase order. The purchase order interface 702D may include input fields for specifying action parameters such as product, amount, and destination, along with controls for confirming or canceling the action. Action parameters may be pre-populated based on answer content, business rules, historical behavior, predictive outputs, or user entitlements.

The present methods and systems may be computer-implemented. FIG. 8 shows a block diagram depicting a system/environment 800 comprising non-limiting examples of a computing device 801 and a server 802 connected through a network 804. Either of the computing device 801 or the server 802 may be a computing device, such as any of the devices of the system 100 shown in FIG. 1A. In an aspect, some or all steps of any described method may be performed on a computing device as described herein. The computing device 801 may comprise one or multiple computers configured to store application data 829, and/or the like. The server 802 may comprise one or multiple computers configured to store assistant data 829. Multiple servers 802 may communicate with the computing device 801 via the through the network 804. The computing device 801 and the server 802 may be a digital computer that, in terms of hardware architecture, generally includes a processor 808, system memory 810, input/output (I/O) interfaces 812, and network interfaces 814. These components (808, 810, 812, and 814) are communicatively coupled via a local interface 816. The local interface 816 may be, for example, but not limited to, one or more buses or other wired or wireless connections, as is known in the art. The local interface 816 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 808 may be a hardware device for executing software, particularly that stored in system memory 810. The processor 808 may be any custom made or commercially available processor, a central processing unit (CPU), an auxiliary processor among several processors associated with the computing device 801 and the server 802, a semiconductor-based microprocessor (in the form of a microchip or chip set), or generally any device for executing software instructions. When the computing device 801 and/or the server 802 is in operation, the processor 808 may execute software stored within the system memory 810, to communicate data to and from the system memory 810, and to generally control operations of the computing device 801 and the server 802 pursuant to the software. The I/O interfaces 812 may be used to receive user input from, and/or for providing system output to, one or more devices or components. User input may be provided via, for example, a keyboard and/or a mouse. System output may be provided via a display device and a printer (not shown).

I/O interfaces 812 may include, for example, a serial port, a parallel port, a Small Computer System Interface (SCSI), an infrared (IR) interface, a radio frequency (RF) interface, and/or a universal serial bus (USB) interface. The network interface 814 may be used to transmit and receive from the computing device 801 and/or the server 802 on the network 804. The network interface 814 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 814 may include address, control, and/or data connections to enable appropriate communications on the network 804. The system memory 810 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 810 may incorporate electronic, magnetic, optical, and/or other types of storage media.

Note that the system memory 810 may have a distributed architecture, where various components are situated remote from one another, but may be accessed by the processor 808. The software in system memory 810 may include one or more software programs, each of which comprises an ordered listing of executable instructions for implementing logical functions. In the example of FIG. 8, the software in the system memory 810 of the computing device 801 may comprise the application data 829, the client application 825, and a suitable operating system (O/S) 818. In the example of FIG. 8, the software in the system memory 810 of the server 802 may comprise the assistant data 829, the assistant application 824, and a suitable operating system (O/S) 818. The operating system 818 essentially controls the execution of other computer programs and provides scheduling, input-output control, file and data management, memory management, and communication control and related services. For purposes of illustration, application programs and other executable program components such as the operating system 818 are shown herein as discrete blocks, although it is recognized that such programs and components may reside at various times in different storage components of the computing device 801 and/or the server 802.

An implementation of the system/environment 800 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

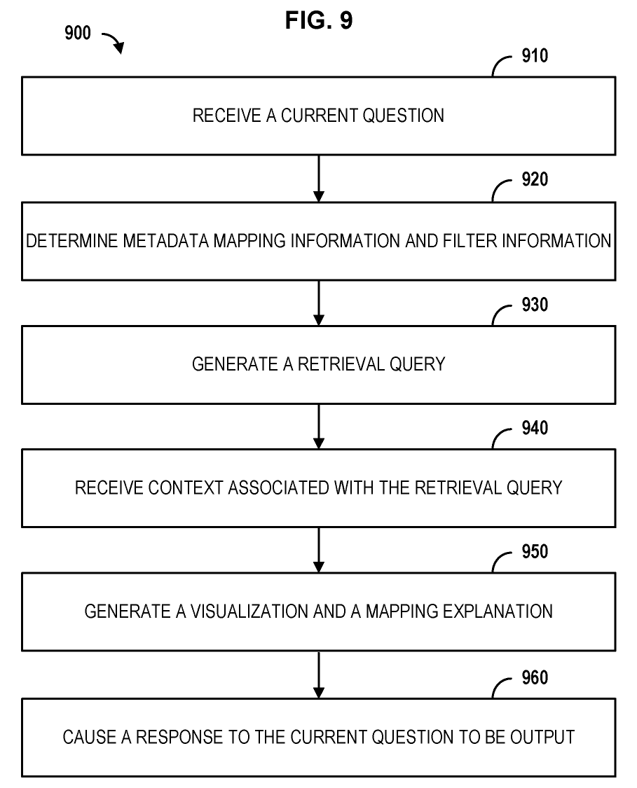

Referring to FIG. 9, a method 900 for processing natural-language queries and generating responses is shown. The method 900 may be performed by one or more components of the system 100 (e.g., the computing device 102 shown in FIG. 1A) and/or the system 150 (e.g., the assistant application 158 shown in FIG. 1B) described herein. The method 900 may also be performed by components of the architecture 180 shown in FIG. 1C, including the supervisor 182, router 184, global assistants 186 (e.g., the cross assistant 186A, the platform assistant 186B, or the help assistant 186C), custom assistants 188 (e.g., the assistant 1 188A), or contextual assistants 190 (e.g., the data prep 190A assistant or the AutoML 190B assistant).

At step 910, the computing device 102 of the system 100 or the assistant application 158 of the system 150 receives, based on user input (e.g., from the user 153 shown in FIG. 1B), a current question (e.g., the current question 162 shown in FIG. 1B). The current question may comprise the user input. The current question may be submitted by a user through an assistant interface (e.g., the assistant interface 202 shown in FIG. 2A). The current question may correspond to a natural-language request related to data analysis, visualization generation, or other analytical operations. The current question may include explicit or implicit references to entities, measures, dates, places, categories, comparisons, preferred chart types, forecast horizons, or desired operational actions.

At step 920, the computing device 102 or the assistant application 158 determines metadata mapping information (e.g., as determined at step 304 shown in FIG. 3) and filter information (e.g., as determined at step 306 shown in FIG. 3) based on the current question. The metadata mapping information may map one or more terms of the current question to one or more semantic objects of at least one analytical application (e.g., the apps 188C shown in FIG. 1C) and at least one knowledge base (e.g., the knowledge 188B shown in FIG. 1C). The metadata mapping information may identify how terms in the current question correspond to semantic objects, measures, dimensions, master items, or knowledge-base sources. The filter information may identify temporal constraints, categorical constraints, geographical constraints, thresholds, or ranking criteria associated with the current question.

Determining the filter information may comprise determining at least one of a temporal filter, a categorical filter, a geographical filter, a threshold filter, a ranking filter, or a comparison filter based on the current question. The ML module 102A of the computing device 102 or the LLM 160 of the system 150 may assist in determining the metadata mapping information and the filter information. The metadata mapping information may be determined by resolving at least one term of the current question using a logical model, business logic, a business glossary (e.g., the glossary 190C assistant shown in FIG. 1C), a synonym list, a master item, or a description associated with an analytical application.

At step 930, the computing device 102 or the assistant application 158 generates a retrieval query based on the metadata mapping information and the filter information determined in step 920. The retrieval query may identify the one or more semantic objects and may incorporate the filter information. The retrieval query may be configured to retrieve relevant context (e.g., the context 166 shown in FIG. 1B) from one or more analytical applications, knowledge bases, or vector databases. The retrieval query may be formed to query the data stores 106, 108, 110 of the system 100 or the vector database 156 of the system 150.

At step 940, the computing device 102 or the assistant application 158 receives context (e.g., the context 166 shown in FIG. 1B) associated with the retrieval query. The context may be received from the at least one analytical application and the at least one knowledge base based on the retrieval query. Receiving the context may comprise receiving structured context from the at least one analytical application and receiving unstructured context from the at least one knowledge base. Receiving the structured context may comprise receiving at least one of a measure or a dimension from the at least one analytical application. Receiving the unstructured context may comprise receiving at least one embedding from a vector database (e.g., the vector database 156 shown in FIG. 1B) storing embeddings associated with document content. The context may include structured context retrieved from analytical applications stored in the data stores 106, 108, 110. The context may include unstructured context retrieved from knowledge bases or the vector database 156. The context may include both structured context and unstructured context. The retrieved context may be used to support answer generation and provide grounding for the response. Other examples are possible as well.

At step 950, the computing device 102 or the assistant application 158 generates a visualization (e.g., as generated at step 308A shown in FIG. 3) and a mapping explanation (e.g., as generated at step 308B shown in FIG. 3) based on the retrieved context, the metadata mapping information, and the filter information. The visualization may be generated by performing calculations using an in-memory associative engine (e.g., the associative engine 170 shown in FIG. 1B or the AE module 102B shown in FIG. 1A). The visualization may represent data associated with the one or more semantic objects. Calculation results produced by the in-memory associative engine may be deterministic and traceable independently of a large language model (e.g., the LLM 160 shown in FIG. 1B). The deterministic nature of the calculation results may ensure that the same query run multiple times returns the same result. The traceability of the calculation results may enable verification and auditing of how the visualization was generated without relying on the large language model. The visualization may comprise a chart (e.g., as shown in the graphical answer card 706 of FIGS. 7E-7H), a sheet object (e.g., as generated by the processing engine 212 shown in FIG. 2A), or other graphical representation of the analytical results.

In some aspects, the in-memory associative engine may maintain state vectors that track a status of data points and field values. The state vectors may update in response to selections to reflect which field values are selected, possible, or excluded. The state vectors may be binary arrays that instantly update when selections are made by a user. The in-memory associative engine may store data using symbol tables containing one row per distinct value for each field and data tables containing bit-stuffed pointers that reference the symbol tables. The bit-stuffed pointers may be compressed, using only the exact number of bits needed to represent the distinct values in each field. The in-memory associative engine may perform logical inference prior to calculations to determine which data is relevant to current selections. The logical inference may happen virtually instantaneously because there is no number crunching involved, just logical evaluation of relationships.

The mapping explanation may be generated based on the one or more terms, the metadata mapping information, and the filter information. The mapping explanation may identify how the current question was interpreted independently of the large language model based at least in part on the calculation results produced by the in-memory associative engine. The mapping explanation (e.g., as displayed in the explanation interface 404 shown in FIGS. 4A-4B or the explanation interface 700B shown in FIG. 7B) may identify how the current question was interpreted, which semantic objects were selected, which filters were applied, and which sources were used. The LLM 160 may assist in generating the mapping explanation by providing an explanation of the metadata mappings and filters.

At step 960, the computing device 102 or the assistant application 158 causes a response (e.g., the final response 168 shown in FIG. 1B) to the current question to be output. The response may comprise the visualization and the mapping explanation. The response may further comprise at least one of a source citation, a source-detail control (e.g., the source-detail panel 702A shown in FIGS. 7I-7J), an answer breakdown by source, a confidence indication, or a feedback control. The response may include source citations, confidence indications, or suggested follow-up actions (e.g., the follow-up action input 702B shown in FIGS. 7K-7L). The response may be presented through an assistant interface (e.g., the assistant interface 202 shown in FIG. 2A or the answer interface 402 shown in FIGS. 4A-4B), an external tool interface, or another output mechanism. The response may further include a control for viewing sources, a control for saving the answer (e.g., as shown in the answer-saving interface 700C of FIGS. 7C-7D), a control for adding the answer to a sheet, or a control for initiating a follow-up workflow (e.g., the purchase order interface 702D shown in FIG. 7M).

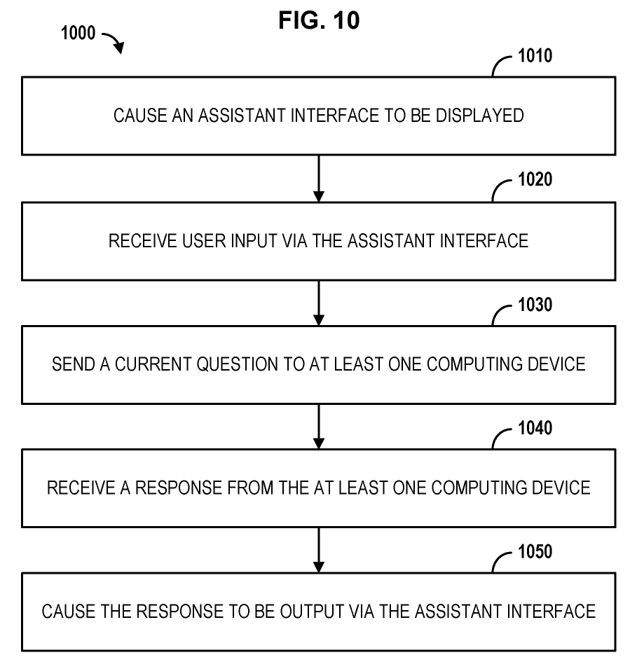

Referring to FIG. 10, a method 1000 for processing natural-language queries via an assistant interface is shown. The method 1000 may be performed by one or more components of the system 100 (e.g., the computing device 102 shown in FIG. 1A) and/or the system 150 (e.g., the assistant application 158 shown in FIG. 1B) described herein. The method 1000 may also be performed by components of the architecture 180 shown in FIG. 1C, with the supervisor 182 and router 184 coordinating query processing across the global assistants 186 (e.g., the cross assistant 186A, the platform assistant 186B, or the help assistant 186C), custom assistants 188 (e.g., the assistant 1 188A), or contextual assistants 190 (e.g., the data prep 190A assistant or the AutoML 190B assistant).

At step 1010, a computing device (e.g., the computing device 102 of the system 100 or the computing device 801 of the system 800) causes an assistant interface (e.g., the assistant interface 202 shown in FIG. 2A) to be displayed. A client application (e.g., the client application 825 shown in FIG. 8) executing on a user device may cause the assistant interface to be displayed. The assistant interface may be configured to receive user input and display responses. The assistant interface may comprise a native application interface, a web-based interface, an embedded chat interface, a mobile interface, or another user-facing surface configured to submit questions and display answers. The assistant interface may correspond to the assistant interface 202 described with reference to FIGS. 2A-2C.

At step 1020, the computing device receives user input via the assistant interface. The user input may comprise a current question (e.g., the current question 162 shown in FIG. 1B). The current question may correspond to a natural-language question or request related to data analysis, visualization, or other analytical operations. The user input may be received from a user (e.g., the user 153 shown in FIG. 1B).

At step 1030, the computing device sends, based on the user input, the current question to at least one computing device. The at least one computing device may include or communicate with a machine-learning module (e.g., the ML module 102A shown in FIG. 1A), one or more large language models (e.g., the LLM 160 shown in FIG. 1B), a semantic model service, a knowledge-base service (e.g., the knowledge 188B shown in FIG. 1C), an analytics engine (e.g., the associative engine 170 shown in FIG. 1B), or other processing components configured to interpret and respond to the current question. For example, the current question may be sent to the computing device 102 of the system 100. The computing device 102 may include the ML module 102A. The current question may also be sent to the server 804 of the system 800. The server 804 may include the assistant application 824.

With continued reference to FIG. 10, at step 1040, the computing device receives, based on the current question, a response (e.g., the final response 168 shown in FIG. 1B) from the at least one computing device. The response may comprise a visualization (e.g., as generated at step 308A shown in FIG. 3) and a mapping explanation (e.g., as generated at step 308B shown in FIG. 3). The response may also include metadata mapping information (e.g., as determined at step 304 shown in FIG. 3), filter information (e.g., as determined at step 306 shown in FIG. 3), retrieved context (e.g., the context 166 shown in FIG. 1B) from analytical applications (e.g., the apps 188C shown in FIG. 1C) or knowledge bases (e.g., the knowledge 188B shown in FIG. 1C), visualization specifications, citations, or other analytical outputs generated based on the current question. The visualization may comprise a chart (e.g., as shown in the graphical answer card 706 of FIGS. 7E-7H), a sheet object (e.g., as generated by the processing engine 212 shown in FIG. 2A), or other graphical representation of analytical results. The mapping explanation (e.g., as displayed in the explanation interface 404 shown in FIGS. 4A-4B or the explanation interface 700B shown in FIG. 7B) may identify how the current question was interpreted, which semantic objects were selected, which filters were applied, and which sources were used.

The at least one computing device may be configured to determine metadata mapping information by mapping one or more terms of the current question to one or more semantic objects of at least one analytical application (e.g., the apps 188C shown in FIG. 1C) and at least one knowledge base (e.g., the knowledge 188B shown in FIG. 1C), and to determine filter information based on the current question. The visualization may represent data associated with the one or more semantic objects.

At step 1050, the computing device causes, based on the response, the visualization and the mapping explanation to be output via the assistant interface (e.g., the assistant interface 202 shown in FIG. 2A or the answer interface 402 shown in FIGS. 4A-4B). The output response may comprise one or more of a natural-language answer, a chart, a sheet, a source citation, a source-detail panel (e.g., the source-detail panel 702A shown in FIGS. 7I-7J), an explanation card (e.g., the explanation interface 404 shown in FIGS. 4A-4B), a confidence indicator, or a suggested follow-up action (e.g., the follow-up action input 702B shown in FIGS. 7K-7L). The assistant interface may present the visualization and the mapping explanation to the user.

In some cases, the computing device may receive, based on the assistant interface, follow-up user input comprising a follow-up question (e.g., as processed by the follow-up question classification 606 shown in FIG. 6). The computing device may send, based on the follow-up user input, the follow-up question to the at least one computing device. The at least one computing device may process the follow-up question (e.g., using the processing flow 600 shown in FIG. 6) and return an updated response.

In some cases, the computing device may store, based on the current question and the response, conversation history (e.g., the conversation history 604 shown in FIG. 6) associated with the current question and the response. The conversation history may be stored in the data stores 106, 108, 110 of the system 100, in the vector database 156 of the system 150, or in the memory 810 of the system 800. The conversation history may enable context-aware processing of subsequent questions.

In some cases, an external client may communicate with the system 100 or the system 150 through an application programming interface, a natural-language query interface, a tool server, a model-context protocol server, or another machine-consumable interface. The external client may include an external artificial-intelligence assistant. The external client may perform the method 1000 by sending questions (e.g., the current question 162 shown in FIG. 1B) to the system 100 or the system 150 and receiving responses (e.g., the final response 168 shown in FIG. 1B) via the machine-consumable interface. Other examples are possible as well.

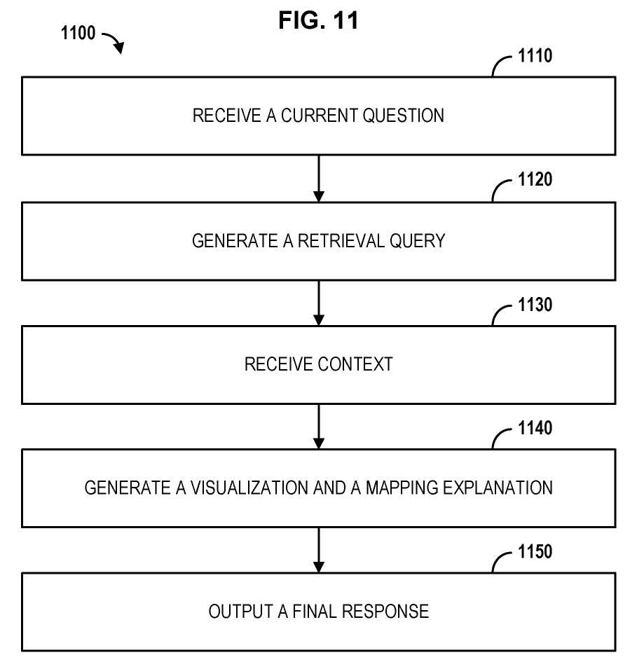

Referring to FIG. 11, a method 1100 for processing natural-language queries using cross-application routing is shown. The method 1100 may be performed by one or more components of the system 100 (e.g., the computing device 102 shown in FIG. 1A) and/or the system 150 (e.g., the assistant application 158 shown in FIG. 1B) described herein. The method 1100 may also be performed by components of the architecture 180 shown in FIG. 1C, including the supervisor 182, router 184, global assistants 186 (e.g., the cross assistant 186A, the platform assistant 186B, or the help assistant 186C), custom assistants 188 (e.g., the assistant 1 188A), or contextual assistants 190 (e.g., the data prep 190A assistant or the AutoML 190B assistant). The method 1100 may enable the system to automatically identify relevant analytical applications based on the content of a user’s question without requiring the user to explicitly select an application before submitting a query.

At step 1110, the computing device 102 of the system 100 or the assistant application 158 of the system 150 receives, based on user input (e.g., from the user 153 shown in FIG. 1B), a current question (e.g., the current question 162 shown in FIG. 1B). The current question may comprise the user input. The current question may be submitted by a user through an assistant interface (e.g., the assistant interface 202 shown in FIG. 2A). The current question may correspond to a natural-language request related to data analysis, visualization generation, or other analytical operations.

At step 1120, the computing device 102 or the assistant application 158 generates a retrieval query based on the current question. Generating the retrieval query may comprise comparing one or more terms of the current question against vectorized profiles of a plurality of analytical applications (e.g., the apps 188C shown in FIG. 1C) to identify at least one analytical application from among the plurality without requiring prior user selection of the at least one analytical application. Each vectorized profile of the vectorized profiles may comprise embeddings derived from metadata, semantic objects, measures, dimensions, and business-logic entities of a respective analytical application. The embeddings may represent the metadata, the semantic objects, the measures, the dimensions, and the business-logic entities of the respective analytical application.

In some aspects, the vectorized profiles may be stored in a vector database (e.g., the vector database 156 shown in FIG. 1B). Comparing the one or more terms may comprise breaking the current question into vectors and comparing the vectors against the vector database. The natural-language application-search service 208 shown in FIG. 2A may perform the comparison of the one or more terms against the vectorized profiles. The plurality of analytical applications may be accessible within a customer environment. The at least one analytical application may be identified based on semantic similarity between the one or more terms and the vectorized profiles. This cross-application routing may enable the system 150 to automatically identify relevant applications based on the content of the user’s 153 question rather than requiring the user 153 to explicitly select an application before submitting a query.

At step 1130, the computing device 102 or the assistant application 158 receives context (e.g., the context 166 shown in FIG. 1B) based on the retrieval query. The context may be received from the at least one analytical application and at least one knowledge base (e.g., the knowledge 188B shown in FIG. 1C). Receiving the context may comprise receiving structured context from the at least one analytical application and receiving unstructured context from the at least one knowledge base. The structured context may comprise measures, dimensions, or other semantic objects from the at least one analytical application. The unstructured context may comprise embeddings or document passages from the at least one knowledge base. The context may be retrieved from the data stores 106, 108, 110 of the system 100 or the vector database 156 of the system 150.

At step 1140, the computing device 102 or the assistant application 158 generates a visualization and a mapping explanation based on the context. The visualization may represent data associated with one or more semantic objects of the at least one analytical application. In some aspects, generating the visualization may comprise performing calculations using an in-memory associative engine (e.g., the associative engine 170 shown in FIG. 1B or the AE module 102B shown in FIG. 1A). Calculation results produced by the in-memory associative engine may be deterministic and traceable independently of a large language model (e.g., the LLM 160 shown in FIG. 1B). The visualization may comprise a chart (e.g., as shown in the graphical answer card 706 of FIGS. 7E-7H), a sheet object (e.g., as generated by the processing engine 212 shown in FIG. 2A), or other graphical representation of the analytical results.

The mapping explanation may be generated based on the one or more terms and the context. The mapping explanation may identify how at least a portion of the current question was interpreted, which of the one or more semantic objects were selected, and which sources were used to generate the final response. The mapping explanation (e.g., as displayed in the explanation interface 404 shown in FIGS. 4A-4B or the explanation interface 700B shown in FIG. 7B) may identify which analytical applications were automatically selected based on the cross-application routing, how the one or more terms were matched to the vectorized profiles, and which semantic objects from the identified applications were used to generate the visualization.

At step 1150, the computing device 102 or the assistant application 158 causes a final response to be output. The final response may comprise the visualization and the mapping explanation. The final response may further comprise at least one of a source citation, a source-detail panel (e.g., the source-detail panel 702A shown in FIGS. 7I-7J), a confidence indication, or a feedback control. The final response may be presented through an assistant interface (e.g., the assistant interface 202 shown in FIG. 2A or the answer interface 402 shown in FIGS. 4A-4B), an external tool interface, or another output mechanism. The final response may indicate which analytical applications were automatically identified and used to generate the response, providing transparency regarding the cross-application routing performed by the system.

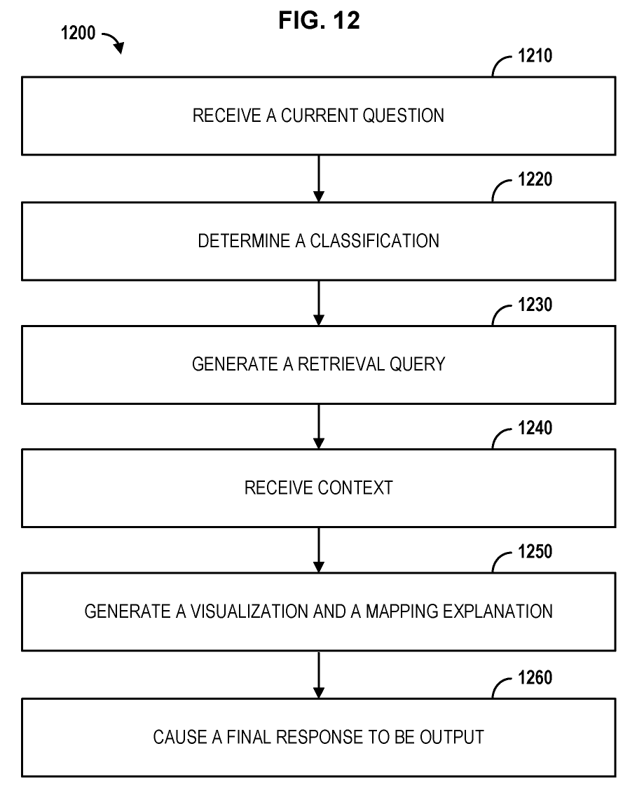

Referring to FIG. 12, a method 1200 for processing natural-language queries using pre-classification and an in-memory associative engine is shown. The method 1200 may be performed by one or more components of the system 100 (e.g., the computing device 102 shown in FIG. 1A) and/or the system 150 (e.g., the assistant application 158 shown in FIG. 1B) described herein. The method 1200 may also be performed by components of the architecture 180 shown in FIG. 1C, including the supervisor 182, router 184, global assistants 186 (e.g., the cross assistant 186A, the platform assistant 186B, or the help assistant 186C), custom assistants 188 (e.g., the assistant 1 188A), or contextual assistants 190 (e.g., the data prep 190A assistant or the AutoML 190B assistant). The method 1200 may enable the system to classify questions into analysis types prior to invoking a large language model, thereby guiding the LLM 160 to perform specific types of analyses rather than generating irrelevant or inappropriate answers or visualizations.

At step 1210, the computing device 102 of the system 100 or the assistant application 158 of the system 150 receives, based on user input (e.g., from the user 153 shown in FIG. 1B), a current question (e.g., the current question 162 shown in FIG. 1B). The current question may comprise the user input. The current question may be submitted by a user through an assistant interface (e.g., the assistant interface 202 shown in FIG. 2A). The current question may correspond to a natural-language request related to data analysis, visualization generation, or other analytical operations.

At step 1220, the computing device 102 or the assistant application 158 determines, prior to invoking a large language model (e.g., the LLM 160 shown in FIG. 1B), a classification of the current question into one or more analysis types. The one or more analysis types may comprise at least one of a forecasting analysis, a clustering analysis, a ranking analysis, a comparative analysis, or an aggregation analysis. The classification may be performed by a data processing service (e.g., the data processing service 210 shown in FIG. 2A) prior to invoking the large language model. The classifications bundles 210A shown in FIG. 2A may store classification rules, patterns, or models used to classify questions into analysis types. This pre-LLM classification may segment the current question 162 into an analysis type and provide direction to downstream processing components based on the classified analysis type.

At step 1230, the computing device 102 or the assistant application 158 generates a retrieval query based on the classification and the current question. The retrieval query may be configured to retrieve relevant context from at least one analytical application (e.g., the apps 188C shown in FIG. 1C) and at least one knowledge base (e.g., the knowledge 188B shown in FIG. 1C). The retrieval query may be formed based at least in part on the classification determined at step 1220, enabling the system to target retrieval operations toward sources and semantic objects relevant to the classified analysis type.

At step 1240, the computing device 102 or the assistant application 158 receives context (e.g., the context 166 shown in FIG. 1B) based on the retrieval query. The context may be received from the at least one analytical application and the at least one knowledge base. The context may comprise data from the at least one analytical application and the at least one knowledge base. The context may be retrieved from the data stores 106, 108, 110 of the system 100 or the vector database 156 of the system 150.

At step 1250, the computing device 102 or the assistant application 158 generates a visualization and a mapping explanation based on the classification and the context. The visualization may be generated by performing calculations using an in-memory associative engine (e.g., the associative engine 170 shown in FIG. 1B or the AE module 102B shown in FIG. 1A). The visualization may represent data associated with one or more semantic objects of the at least one analytical application. Calculation results produced by the in-memory associative engine may be deterministic and traceable independently of the large language model (e.g., the LLM 160 shown in FIG. 1B). The deterministic nature of the calculation results may ensure that the same query run multiple times returns the same result. The visualization may comprise a chart (e.g., as shown in the graphical answer card 706 of FIGS. 7E-7H), a sheet object (e.g., as generated by the processing engine 212 shown in FIG. 2A), or other graphical representation of the analytical results.

In some aspects, the in-memory associative engine may maintain state vectors that track a status of data points and field values. The state vectors may update in response to selections to reflect which field values are selected, possible, or excluded. The in-memory associative engine may store data using symbol tables containing one row per distinct value for each field and data tables containing bit-stuffed pointers that reference the symbol tables. The in-memory associative engine may perform logical inference prior to calculations to determine which data is relevant to current selections.

The mapping explanation may be generated based on the classification, the context, and the calculation results produced by the in-memory associative engine. The mapping explanation may identify how the current question was classified into the one or more analysis types and how the one or more semantic objects were selected. The mapping explanation (e.g., as displayed in the explanation interface 404 shown in FIGS. 4A-4B or the explanation interface 700B shown in FIG. 7B) may identify how at least a portion of the current question was interpreted, which of the one or more semantic objects were selected, which filters were applied, and which sources were used to generate the final response. The classification may guide the large language model to perform a specific type of analysis corresponding to the one or more analysis types.

At step 1260, the computing device 102 or the assistant application 158 causes a final response to be output. The final response may comprise the visualization and the mapping explanation. The final response may further comprise at least one of a source citation, a source-detail control (e.g., the source-detail panel 702A shown in FIGS. 7I-7J), an answer breakdown by source, a confidence indication, or a feedback control. The final response may be presented through an assistant interface (e.g., the assistant interface 202 shown in FIG. 2A or the answer interface 402 shown in FIGS. 4A-4B), an external tool interface, or another output mechanism. The final response may indicate the analysis type into which the current question was classified, providing transparency regarding the pre-LLM classification performed by the system.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, based on user input, a current question, the user input comprising the current question;
determining, based on the current question, metadata mapping information, the metadata mapping information mapping one or more terms of the current question to one or more semantic objects of at least one analytical application and at least one knowledge base;
determining, based on the current question, filter information;
generating, based on the metadata mapping information and the filter information, a retrieval query, the retrieval query identifying the one or more semantic objects and incorporating the filter information;
receiving, based on the retrieval query, context from the at least one analytical application and the at least one knowledge base;
generating, based on the metadata mapping information, the filter information, and the context, a visualization by performing calculations using an in-memory associative engine, the visualization representing data associated with the one or more semantic objects, wherein calculation results produced by the in-memory associative engine are deterministic and traceable independently of a large language model;
generating, based on the one or more terms, the metadata mapping information, and the filter information, a mapping explanation, the mapping explanation identifying how the current question was interpreted independently of the large language model based at least in part on the calculation results; and
causing a final response to be output, the final response comprising the visualization and the mapping explanation.

2. The method of claim 1, wherein the in-memory associative engine maintains state vectors that track a status of data points and field values, and wherein the state vectors update in response to selections to reflect which field values are selected, possible, or excluded.

3. The method of claim 1, wherein the in-memory associative engine stores data using symbol tables containing one row per distinct value for each field and data tables containing bit-stuffed pointers that reference the symbol tables.

4. The method of claim 1, wherein the in-memory associative engine performs logical inference prior to calculations to determine which data is relevant to current selections.

5. The method of claim 1, wherein determining the metadata mapping information comprises resolving at least one term of the current question using at least one of a logical model, business logic, a business glossary, a synonym list, a master item, or a description associated with the at least one analytical application.

6. The method of claim 1, wherein determining the filter information comprises determining at least one of a temporal filter, a categorical filter, a geographical filter, a threshold filter, a ranking filter, or a comparison filter based on the current question.

7. The method of claim 1, wherein the final response further comprises at least one of a source citation, a source-detail control, an answer breakdown by source, a confidence indication, or a feedback control.

8. A method comprising:
receiving, based on user input, a current question, the user input comprising the current question;
generating, based on the current question, a retrieval query by comparing one or more terms of the current question against vectorized profiles of a plurality of analytical applications to identify at least one analytical application from among the plurality without requiring prior user selection of the at least one analytical application;
receiving, based on the retrieval query, context from the at least one analytical application and at least one knowledge base;
generating, based on the context, a visualization, the visualization representing data associated with one or more semantic objects of the at least one analytical application;
generating, based on the one or more terms and the context, a mapping explanation; and
causing, a final response to be output, the final response comprising the visualization and the mapping explanation.

9. The method of claim 8, wherein the vectorized profiles are stored in a vector database, and wherein comparing the one or more terms comprises breaking the current question into vectors and comparing the vectors against the vector database.

10. The method of claim 8, wherein the plurality of analytical applications are accessible within a customer environment, and wherein the at least one analytical application is identified based on semantic similarity between the one or more terms and the vectorized profiles.

11. The method of claim 8, wherein generating the visualization comprises performing calculations using an in-memory associative engine, wherein calculation results produced by the in-memory associative engine are deterministic and traceable independently of a large language model.

12. The method of claim 8, wherein the mapping explanation identifies how at least a portion of the current question was interpreted, which of the one or more semantic objects were selected, and which sources were used to generate the final response.

13. The method of claim 8, wherein receiving the context comprises receiving, structured context from the at least one analytical application, and receiving unstructured context from the at least one knowledge base.

14. The method of claim 8, wherein the final response further comprises at least one of a source citation, a source-detail panel, a confidence indication, or a feedback control.

15. A method comprising:
receiving, based on user input, a current question, the user input comprising the current question;
determining, prior to invoking a large language model, a classification of the current question into one or more analysis types;
generating, based on the classification and the current question, a retrieval query;
receiving, based on the retrieval query, context from at least one analytical application and at least one knowledge base;
generating, based on the classification and the context, a visualization by performing calculations using an in-memory associative engine, the visualization representing data associated with one or more semantic objects, wherein calculation results produced by the in-memory associative engine are deterministic and traceable independently of the large language model;
generating, based on the classification and the context, a mapping explanation; and
causing a final response to be output, the final response comprising the visualization and the mapping explanation.

16. The method of claim 15, wherein determining the classification is performed by a data processing service prior to invoking the large language model, and wherein the retrieval query and the visualization are generated based at least in part on the classification.

17. The method of claim 15, wherein the classification guides the large language model to perform a specific type of analysis corresponding to the one or more analysis types, wherein the one or more analysis types comprises at least one of a forecasting analysis, a clustering analysis, a ranking analysis, a comparative analysis, or an aggregation analysis.

18. The method of claim 15, wherein the in-memory associative engine maintains state vectors that track a status of data points and field values, and wherein the state vectors update in response to selections.

19. The method of claim 15, wherein generating the mapping explanation comprises generating an identification of how at least a portion of the current question was interpreted, which of the one or more semantic objects were selected, which filters were applied, and which sources were used to generate the final response.

20. The method of claim 15, wherein the final response further comprises at least one of a source citation, a source-detail control, an answer breakdown by source, a confidence indication, or a feedback control.
